(19) United States
(12) Patent Application Publication
(10) Pub. No.: US 2015/0139589 A1
(43) Pub. Date: May 21, 2015

(54) OPTICAL FIBER CONNECTOR, METHOD FOR MANUFACTURING OPTICAL FIBER CONNECTOR, METHOD FOR CONNECTING OPTICAL FIBER CONNECTOR AND OPTICAL FIBER, AND ASSEMBLED BODY OF OPTICAL FIBER CONNECTOR AND OPTICAL FIBER

(71) Applicants: Daichi Sakai, Ibaraki (JP); Toshihiro Kuroda, Tochigi (JP); Kazushi Minakawa, Ibaraki (JP); Hiromichi Aoki, Ibaraki (JP); Hiroshi Betsui, Ibaraki (JP); Kouta Segawa, Ibaraki (JP); Masao Uchigasaki, Ibaraki (JP); Shigeyuki Yagi, Tochigi (JP); Tomoaki Shibata, Ibaraki (JP)

(72) Inventors: Daichi Sakai, Ibaraki (JP); Toshihiro Kuroda, Tochigi (JP); Kazushi Minakawa, Ibaraki (JP); Hiromichi Aoki, Ibaraki (JP); Hiroshi Betsui, Ibaraki (JP); Kouta Segawa, Ibaraki (JP); Masao Uchigasaki, Ibaraki (JP); Shigeyuki Yagi, Tochigi (JP); Tomoaki Shibata, Ibaraki (JP)

(73) Assignee: HITACHI CHEMICAL COMPANY, LTD., Tokyo (JP)

(21) Appl. No.: 14/413,474

(22) PCT Filed: Aug. 1, 2012
(86) PCT No.: PCT/JP2012/069623

§ 371 Date: Jan. 8, 2015

(51) Int. Cl. G02B 6/38; G02B 6/255; G02B 6/26

(52) U.S. Cl. CPC G02B 6/3807; G02B 6/26; G02B 6/255
USPC 385/76; 216/24; 156/293

(57) ABSTRACT

An optical fiber connector in which: an optical fiber guide member includes a fiber guide side substrate portion forming part of a substrate, a fiber guide pattern, and a lid member; and an optical waveguide includes an optical waveguide side substrate portion adjacent to the fiber guide side substrate portion, an optical waveguide side first lower clad layer, an optical signal transmission core pattern, and an optical waveguide side upper clad layer. The fiber guide pattern is formed of a plurality of guide members aligned parallel to one another at intervals. A space defined by every two adjacent guide members, the fiber guide side substrate portion, and a fiber guide side lid member portion forms a fiber guide groove. The fiber guide groove is present on an extension of the optical signal transmission core pattern in an optical path direction. The optical fiber connector facilitates alignment of an optical fiber and an optical waveguide core and also facilitates mounting of the optical fiber with hardly any misalignment of the optical fiber.

### TECHNICAL FIELD

The present invention relates to an optical fiber connector, a method for manufacturing an optical fiber connector, a method for connecting an optical fiber connector and an optical fiber, and an assembled body of an optical fiber connector and an optical fiber, and more particularly, to an optical fiber connector that facilitates alignment of an optical fiber and an optical waveguide core independently of a substrate with hardly any misalignment of the optical fiber, a method for manufacturing an optical fiber connector, a method for connecting an optical fiber connector and an optical fiber, and an assembled body of an optical fiber connector and an optical fiber.

### BACKGROUND ART

Generally, an optical cable (also called an optical fiber cable) is used extensively for home and industrial information communications due to its capability of allowing high-speed, large-volume information communications. Also, for example, an automobile is equipped with various electrical components (for example, a car navigation system) and an optical cable is adopted for optical communications of these electrical components. PTL 1 discloses an optical cable connector that connects optical cables having optical fibers by butting terminals of the optical fibers together.

In accordance with increase of information capacity, developments are being made in an optical interconnection technique using an optical signal not only in a communication field, such as a trunk line and an access system, but also in information processing within a router and a server. More specifically, in order to use light for a short-range signal transmission between boards of a router and a server device or within a board, an optical waveguide having a higher degree of freedom in wiring and capable of increasing density in comparison with an optical fiber is used as an optical transmission channel.

As a method of joining the optical waveguide and an optical fiber, there is an optical fiber connector described, for example, in PTL 2.

Such an optical fiber connector, however, requires an optical fiber mounting groove be formed by cutting work by means of dicing and therefore work efficiency is poor. In addition, an optical waveguide core is manufactured by photolithography and etching in a step different from the groove cutting step. Hence, the optical fiber is misaligned in some cases. Further, an optical fiber undergoes more significant misalignment in this method unless the optical waveguide is formed on a hard substrate with good dimensional stability, such as a silicon wafer.

PTL 3 discloses a method for connecting an optical fiber and an optical waveguide by attaching a waveguide substrate provided with an optical waveguide and an optical connector carrying an optical fiber to different holders and by firmly fixing end faces of the respective holders. This method, however, is complex because many steps are involved before the connection is completed.

An optical fiber connector described in PTL 4, which includes an optical fiber mounting groove and an optical waveguide provided side by side, aligns the optical waveguide and the optical fiber by a method of introducing an optical fiber fixing adhesive and an optical fiber into the optical fiber mounting groove and pressing the optical fiber connector with a fixing jig from the optical fiber mounting side. This method, however, has a problem that axial misalignment such that can result in an optical loss occurs between the optical fiber and the optical waveguide unless the fixing jig is maintained in a horizontal posture when the optical fiber is fixed.

### CITATION LIST

### Patent Literatures

PTL 1: JP-A-2010-48925

PTL 2: JP-A-2001-201646

PTL 3: JP-A-7-13040

PTL 4: Japanese Patent No. 4577376

### SUMMARY OF INVENTION

### Technical Problem

The present invention has an object to provide an optical fiber connector that facilitates alignment of an optical fiber and an optical waveguide core and also facilitates mounting of the optical fiber with hardly any misalignment of the optical fiber, a method for manufacturing an optical fiber connector, a method for connecting an optical fiber connector and an optical fiber, and an assembled body of an optical fiber connector and an optical fiber.

### Solution to Problem

The inventors discovered that the problems discussed above were solved by an optical fiber connector including an optical fiber guide member provided with a fiber guide pattern having a groove in which an optical fiber is to be fixed and a lid member covering the fiber guide pattern, and configured in such a manner that the optical fiber guide member and an optical waveguide are provided side by side. The present invention was completed on the basis of this knowledge.

In other words, the present invention provides the following (1) through (4).

(1) An optical fiber connector having an optical fiber guide member and an optical waveguide. The optical fiber guide member includes a fiber guide side substrate portion forming part of a substrate, a fiber guide pattern on the fiber guide side substrate portion, and a lid member covering the fiber guide pattern. The optical waveguide includes an optical waveguide side substrate portion adjacent to the fiber guide side substrate portion of the substrate, an optical waveguide side first lower clad layer on the optical waveguide side substrate portion, an optical signal transmission core pattern on the optical waveguide side first lower clad layer, and an optical waveguide side upper clad layer on the optical signal transmission core pattern. The fiber guide pattern is formed of a plurality of guide members aligned parallel to one another at intervals. A space defined by every two adjacent guide members, the fiber guide side substrate portion, and a fiber guide side lid member portion forms a fiber guide groove. The fiber guide groove is present on an extension of the optical signal transmission core pattern in an optical path direction.

(2) A method for manufacturing the optical fiber connector described above, including: a first step of forming an optical waveguide side first lower clad layer by laminating a first lower clad layer on a substrate and etching away the first lower clad layer present in a region in which a fiber guide groove is to be formed; a second step of collectively forming a fiber guide core pattern and an optical signal transmission core pattern by means of etching after a core forming resin layer is laminated on the substrate on which the optical waveguide side first lower clad layer is formed; a third step of forming a fiber guide side upper clad layer, an optical waveguide side upper clad layer, and a fiber guide groove by laminating an upper clad layer forming resin layer on the substrate on which the fiber guide core pattern and the optical signal transmission core pattern are formed and etching away the upper clad layer forming resin layer preset in a region in which the fiber guide groove is to be formed; and a fourth step of forming a lid member covering the fiber guide groove.

(3) A method for connecting an optical fiber connector and an optical fiber by filling an adhesive in the fiber guide groove of the optical fiber connector described above and inserting and installing an optical fiber in the fiber guide groove.

(4) An assembled body of an optical fiber connector and an optical fiber, having the optical fiber connector described above and an optical fiber and an adhesive installed in the fiber guide groove of the optical fiber connector.

### Advantageous Effects of Invention

An optical fiber connector of the present invention facilitates alignment of an optical fiber and an optical waveguide core and also facilitates mounting of the optical fiber with hardly any misalignment of the optical fiber.

### BRIEF DESCRIPTION OF DRAWINGS

FIG. 1 is a plan view showing an optical fiber connector 1 of a first embodiment.

FIG. 2 is a perspective view showing the optical fiber connector 1 of the first embodiment.

FIG. 3 is an end view taken along the line A-A of FIG. 1.

FIG. 4 is an end view taken along the line B-B of FIG. 1.

FIG. 5 is an end view taken along the line C-C of FIG. 1.

FIG. 6 is an end view taken along the line D-D of FIG. 1.

FIG. 7 is an end view taken along a line equivalent to the line A-A of FIG. 1 to show a first manufacturing process of a substrate in the optical fiber connector 1.

FIG. 8 is an end view taken along a line equivalent to the line C-C of FIG. 1 to show the first manufacturing process of the substrate in the optical fiber connector 1.

FIG. 9 is an end view taken along a line equivalent to the line A-A of FIG. 1 to show a second manufacturing process of the substrate in the optical fiber connector 1.

FIG. 10 is an end view taken along a line equivalent to the line C-C of FIG. 1 to show the second manufacturing process of the substrate in the optical fiber connector 1.

FIG. 11 is an end view taken along a line equivalent to the line A-A of FIG. 1 to show a third manufacturing process of the substrate in the optical fiber connector 1.

FIG. 12 is an end view taken along a line equivalent to the line C-C of FIG. 1 to show the third manufacturing process of the substrate in the optical fiber connector 1.

FIG. 13 is an end view taken along a line equivalent to the line A-A of FIG. 1 to show a first step of the optical fiber connector 1.

FIG. 14 is an end view taken along a line equivalent to the line B-B of FIG. 1 to show the first step of the optical fiber connector 1.

FIG. 15 is an end view taken along a line equivalent to the line C-C of FIG. 1 to show the first step of the optical fiber connector 1.

FIG. 16 is an end view taken along a line equivalent to the line D-D of FIG. 1 to show the first step of the optical fiber connector 1.

FIG. 17 is an end view taken along a line equivalent to the line A-A of FIG. 1 to show a second step of the optical fiber connector 1.

FIG. 18 is an end view taken along a line equivalent to the line B-B of FIG. 1 to show the second step of the optical fiber connector 1.

FIG. 19 is an end view taken along a line equivalent to the line C-C of FIG. 1 to show the second step of the optical fiber connector 1.

FIG. 20 is an end view taken along a line equivalent to the line D-D of FIG. 1 to show the second step of the optical fiber connector 1.

FIG. 21 is an end view taken along a line equivalent to the line A-A of FIG. 1 to show a third step of the optical fiber connector 1.

FIG. 22 is an end view taken along a line equivalent to the line B-B of FIG. 1 to show the third step of the optical fiber connector 1.

FIG. 23 is an end view taken along a line equivalent to the line C-C of FIG. 1 to show the third step of the optical fiber connector 1.

FIG. 24 is an end view taken along a line equivalent to the line D-D of FIG. 1 to show the third step of the optical fiber connector 1.

FIG. 25 is a perspective view to show a fifth step and a sixth step of the optical fiber connector 1.

FIG. 26 is an end view taken along a line equivalent to the line A-A of FIG. 1 to show the fifth step and the sixth step of the optical fiber connector 1.

FIG. 27 is an end view taken along a line equivalent to the line B-B of FIG. 1 to show the fifth step and the sixth step of the optical fiber connector 1.

FIG. 28 is an end view taken along a line equivalent to the line A-A of FIG. 1 to show the sixth step of the optical fiber connector 1.

FIG. 29 is an end view taken along a line equivalent to the line B-B of FIG. 1 to show the sixth step of the optical fiber connector 1.

FIG. 30 is an end view of an optical fiber connector 1A taken along a line equivalent to the line A-A of FIG. 1.

FIG. 31 is an end view of the optical fiber connector 1A taken along a line equivalent to the line B-B of FIG. 1.

FIG. 32 is an end view of the optical fiber connector 1A taken along a line equivalent to the line C-C of FIG. 1.

FIG. 33 is an end view of the optical fiber connector 1A taken along a line equivalent to the line D-D of FIG. 1.

FIG. 34 is an end view taken along a line equivalent to the line A-A of FIG. 1 to show a fifth-A step of the optical fiber connector 1A.

FIG. 35 is an end view taken along a line equivalent to the line B-B of FIG. 1 to show the fifth-A step of the optical fiber connector 1A.

FIG. 36 is an end view taken along a line equivalent to the line C-C of FIG. 1 to show the fifth-A step of the optical fiber connector 1A.

FIG. 37 is an end view taken along a line equivalent to the line D-D of FIG. 1 to show the fifth-A step of the optical fiber connector 1A.

FIG. 38 is an end view taken along a line equivalent to the line A-A of FIG. 1 to show a sixth step of the optical fiber connector 1A.

FIG. 39 is an end view taken along a line equivalent to the line B-B of FIG. 1 to show the sixth step of the optical fiber connector 1A.

FIG. 40 is an end view taken along a line equivalent to the line A-A of FIG. 1 to show a fourth step of the optical fiber connector 1A.

FIG. 41 is an end view taken along a line equivalent to the line B-B of FIG. 1 to show the fourth step of the optical fiber connector 1A.

FIG. 42 is an end view taken along a line equivalent to the line C-C of FIG. 1 to show the fourth step of the optical fiber connector 1A.

FIG. 43 is an end view taken along a line equivalent to the line D-D of FIG. 1 to show the fourth step of the optical fiber connector 1A.

FIG. 44 is an end view of an optical fiber connector 1B taken along a line equivalent to the line A-A of FIG. 1.

FIG. 45 is an end view of the optical fiber connector 1B taken along a line equivalent to the line B-B of FIG. 1.

FIG. 46 is an end view of an optical fiber connector 10 taken along a line equivalent to the line A-A of FIG. 1.

FIG. 47 is an end view of the optical fiber connector 10 taken along a line equivalent to the line B-B of FIG. 1.

FIG. 48 is a cross section of an assembled body 70 of the optical fiber connector 1 and an optical fiber to show a method for connecting an optical fiber connector and an optical fiber.

FIG. 49 is a cross section of an assembled body 70A of the optical fiber connector 1A and an optical fiber to show a method for connecting an optical fiber connector and an optical fiber.

FIG. 50 is a cross section of an assembled body 70B of the optical fiber connector 1B and an optical fiber to show a method for connecting an optical fiber connector and an optical fiber.

FIG. 51 is a cross section of an assembled body 70C of the optical fiber connector 10 and an optical fiber to show a method for connecting an optical fiber connector and an optical fiber.

FIG. 52 is a partial enlarged view of FIG. 4.

FIG. 53 is a partial enlarged view of FIG. 6.

FIG. 54 is an end view of an optical fiber connector 1D taken along a line equivalent to the line A-A of FIG. 1.

FIG. 55 is an end view of the optical fiber connector 1D taken along a line equivalent to the line B-B of FIG. 1.

### DESCRIPTION OF EMBODIMENTS

An optical fiber connector of the present invention is an optical fiber connector having an optical fiber guide member and an optical waveguide. The optical fiber guide member includes a fiber guide side substrate portion forming part of a substrate, a fiber guide pattern on the fiber guide side substrate portion, and a lid member covering the fiber guide pattern. The optical waveguide includes an optical waveguide side substrate portion adjacent to the fiber guide side substrate portion of the substrate, an optical waveguide side first lower clad layer on the optical waveguide side substrate portion, an optical signal transmission core pattern on the optical waveguide side first lower clad layer, and an optical waveguide side upper clad layer on the optical signal transmission core pattern. The fiber guide pattern is formed of a plurality of guide members aligned parallel to one another at intervals. A space defined by every two adjacent guide members, the fiber guide side substrate portion, and a fiber guide side lid member portion forms a fiber guide groove. The fiber guide groove is present on an extension of the optical signal transmission core pattern in an optical path direction.

Also, a method for manufacturing an optical fiber connector of the present invention is a method for manufacturing the optical fiber connector described above. The method includes: a first step of forming an optical waveguide side first lower clad layer by laminating a first lower clad layer on a substrate and etching away the first lower clad layer present in a region in which a fiber guide groove is to be formed; a second step of collectively forming a fiber guide core pattern and an optical signal transmission core pattern by means of etching after a core forming resin layer is laminated on the substrate on which the optical waveguide side first lower clad layer is formed; a third step of forming an optical fiber guide member side upper clad layer, an optical waveguide side upper clad layer, and a fiber guide groove by laminating an upper clad layer forming resin layer on the substrate on which the fiber guide core pattern and the optical signal transmission core pattern are formed and etching away the upper clad layer forming resin layer preset in a region in which the fiber guide groove is to be formed; and a fourth step of forming a lid member covering the fiber guide groove.

A method for connecting an optical fiber connector and an optical fiber of the present invention includes a step of filling an adhesive in the fiber guide groove of the optical fiber connector described above and inserting and installing an optical fiber in the fiber guide groove.

An assembled body of an optical fiber connector and an optical fiber of the present invention has the optical fiber connector described above and an optical fiber and an adhesive installed in the fiber guide groove of the optical fiber connector.

According to the optical fiber connector, because the optical fiber guide member and the optical waveguide are provided side by side, an optical fiber and an optical waveguide core can be readily aligned by fixing the optical fiber to the optical fiber guide member. Also, because the optical fiber is guided by the fiber guide pattern and the lid member, the optical fiber hardly undergoes misalignment. Further, the optical fiber and the optical waveguide can be readily fixed by merely inserting the optical fiber into the fiber guide groove.

### First Embodiment

### Structure of Optical Fiber Connector

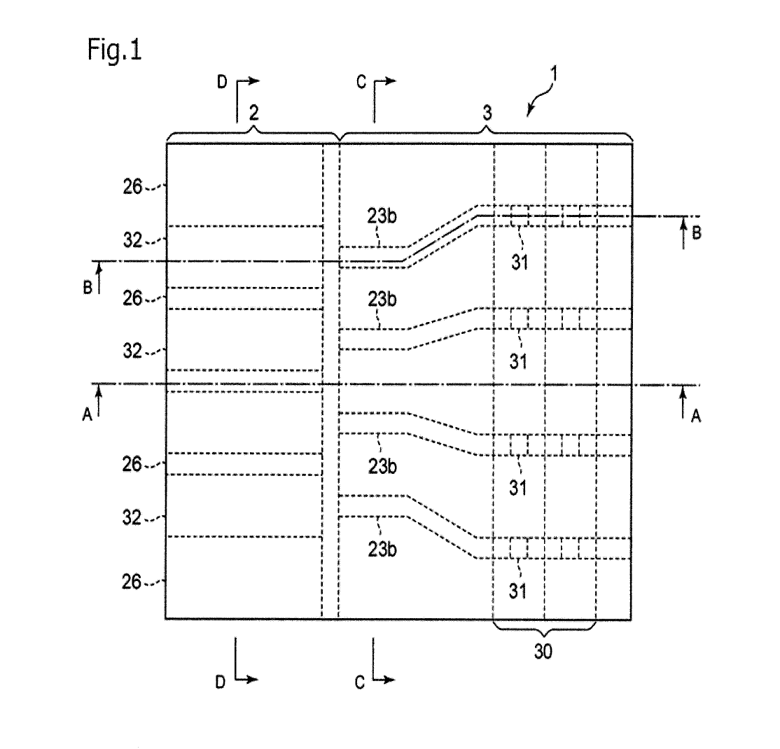

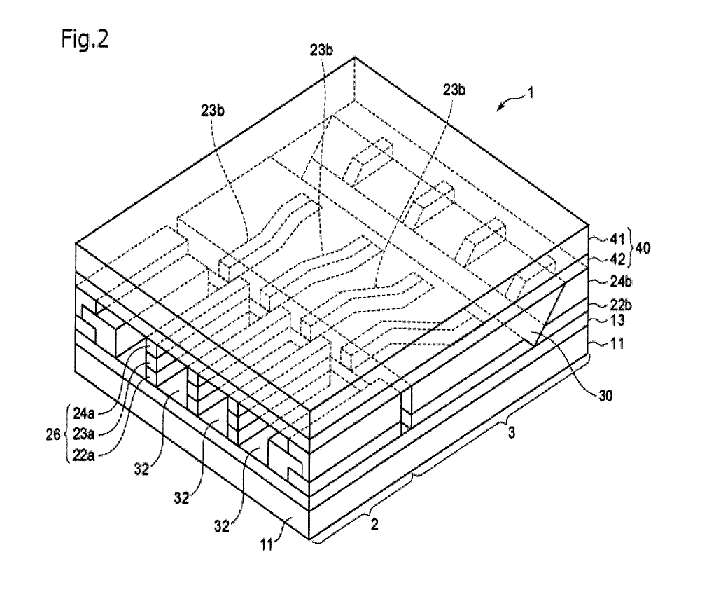

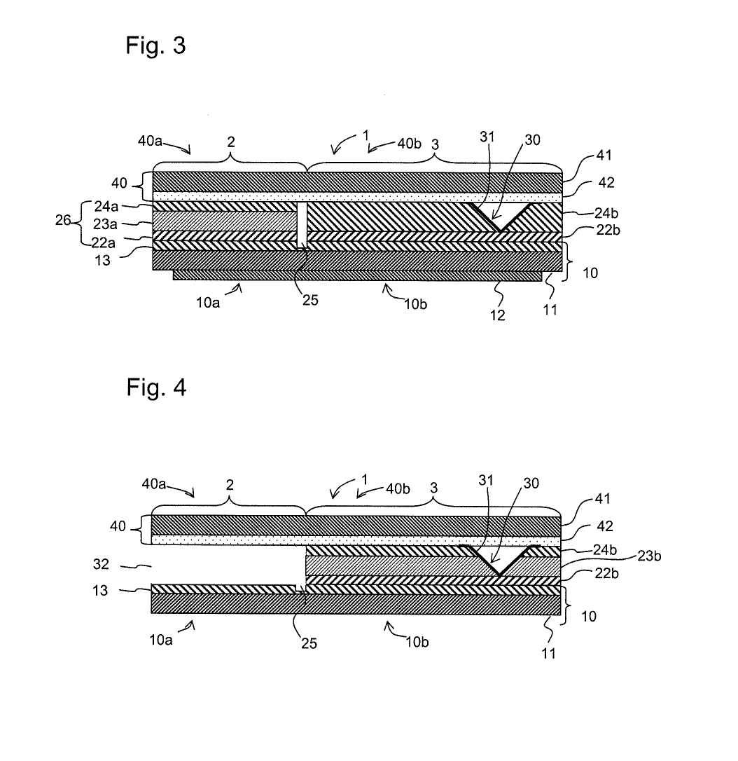

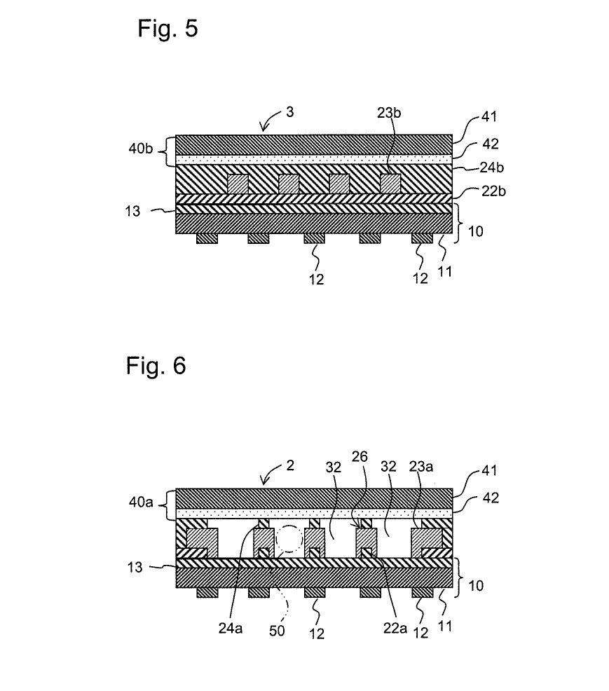

Hereinafter, an optical fiber connector 1 of a first embodiment will be described with reference to the drawings. FIG. 1 is a plan view showing the optical fiber connector 1 of the first embodiment. FIG. 2 is a perspective view showing the optical fiber connector of the first embodiment. FIG. 3 is an end view taken along the line A-A of FIG. 1. FIG. 4 is an end view taken along the line B-B of FIG. 1. FIG. 5 is an end view taken along the line C-C of FIG. 1. FIG. 6 is an end view taken along the line D-D of FIG. 1.

The optical fiber connector 1 of the first embodiment includes an optical fiber guide member 2 and an optical waveguide 3 provided side by side.

The optical fiber guide member 2 is formed of a fiber guide side substrate portion 10a forming part (left side of FIG. 3) of a substrate 10, a fiber guide pattern 26 (FIG. 3) on the fiber guide side substrate portion 10a, and a lid member 40 covering the fiber guide pattern 26.

Also, the optical waveguide 3 includes an optical waveguide side substrate portion 10b adjacent to the fiber guide side substrate portion 10a of the substrate 10, an optical waveguide side first lower clad layer 22b on the optical waveguide side substrate portion 10b, an optical signal transmission core pattern 23b on the optical waveguide side first lower clad layer 22b, and an optical waveguide side upper clad layer 24b on the optical signal transmission core pattern 23b.

The optical fiber guide member 2 and the optical waveguide 3 will now be described more in detail.

The substrate 10 is formed of a substrate main body 11 of a rectangular shape when viewed in plane, metal wires 12 installed on a back surface of the substrate main body 11, and an adhesive layer 13 present substantially across an entire surface of the substrate main body 11. It is preferable that the adhesive layer 13 functions as a second lower clad layer. It should be noted, however, that the adhesive layer 13 may be omitted.

Part (left side of FIG. 3) of the substrate 10 forms the fiber guide side substrate portion 10a and the rest (right side of FIG. 3) forms the optical waveguide side substrate portion 10b.

Also, the lid member 40 is formed of a lid member main body 41 and an adhesive layer 42 present on a back surface of the lid member main body 41. The adhesive layer 42 may be omitted.

In this embodiment, the lid member 40 extends from the optical fiber guide member 2 to the optical waveguide 3. The lid member 40 therefore has a fiber guide side lid member portion 40a covering the optical fiber guide member 2 and an optical waveguide side lid member portion 40b covering the optical waveguide 3. It should be noted, however, that the lid member 40 may not necessarily extend to the optical waveguide 3.

The fiber guide pattern 26 is present on the fiber guide side substrate portion 10a. The fiber guide pattern 26 has a plurality (five in this embodiment) of guide members 126 (FIG. 1 and FIG. 2) which are parallel to one another at intervals. A plurality of the guide members 126 extend parallel to long sides of the substrate 10. A space between every two adjacent guide members 126 forms a fiber guide groove 32.

The fiber guide pattern 26 is formed of a fiber guide side first lower clad layer 22a present on the fiber guide side substrate portion 10a, a fiber guide core pattern 23a present on the fiber guide side first lower clad layer 22a, and a fiber guide side upper clad layer 24a present on the fiber guide core pattern 23a.

As is shown in FIG. 2, the fiber guide side first lower clad layer 22a is formed of a plurality (five in this embodiment) of fiber guide side first lower clad pieces 122 which are parallel to one another at intervals. Likewise, the fiber guide core pattern 23a is formed of a plurality (five in this embodiment) of fiber guide core pieces 123 which are parallel to one another at intervals. Likewise, the fiber guide side upper clad layer 24a is formed of a plurality (five in this embodiment) of fiber guide side upper clad pieces 124 which are parallel to one another at intervals.

Each guide member 126 is formed of the fiber guide side first lower clad piece 122, the fiber guide core piece 123, and the fiber guide side upper clad piece 124.

As is shown in FIG. 2, regarding the three guide members 126 at the center, the fiber guide core piece 123 covers a top surface and side surfaces of the fiber guide side first lower clad piece 122 and extends to the surface of the fiber guide side substrate portion 10a. In other words, it is structured in such a manner that the fiber guide core piece 123 is provided to stand on the fiber guide side substrate portion 10a and the fiber guide side first lower clad piece 122 is present inside the fiber guide core piece 123. Regarding the two guide members 126 at both ends, each fiber guide core piece 123 projects toward the fiber guide groove 32 more than the fiber guide side first lower clad piece 122 and extends to the fiber guide side substrate portion 10a by covering the side surface of the fiber guide side first lower clad piece 122.

Also, the fiber guide side upper clad pieces 124 are present on the top surfaces of the five fiber guide core pieces 123. The fiber guide core pieces 123 and the fiber guide side upper clad pieces 124 together form side surfaces of the fiber guide grooves 32. As is shown in FIG. 6, the side surfaces of the fiber guide core pieces 123 project toward the fiber guide grooves 32 more than the side surfaces of the fiber guide side upper clad pieces 124 provided thereon. Owing to this configuration, a cross section of the fiber guide groove 32 in a direction orthogonal to an optical path forms a T shape. In other words, the fiber guide groove 32 is of a shape in which a narrow width portion defined by the fiber guide core pieces 123 of the adjacent guide members 126 is connected to a narrow width portion defined by the fiber guide side upper clad pieces 124 of these adjacent guide members 126. As has been described, the fiber guide groove 32 is of a T shape and the fiber guide core piece 123 projects toward the fiber guide groove 32 more than the fiber guide side upper clad piece 124. Hence, side portions of optical fibers are substantially held by the fiber guide core pieces 123 of the guide members 126. Consequently, because the side portions of optical fibers can be fixed by the fiber guide core pattern 23a, the optical signal transmission core pattern 23b and the optical fibers can be aligned with accuracy. Further, there can be achieved an excellent advantageous effect that even when the upper clad layer and the lower clad layer are formed at positions slightly displaced from the core pattern during the process of manufacturing, an event that the upper clad layer and the lower clad layer are formed in the fiber guide grooves and interfere with insertion of the optical fibers can be avoided. Also, as has been described above, the side portions of optical fibers are held by the fiber guide core pieces 123. Hence, by designing the fiber guide core pieces 123 in the same mask as an optical signal transmission core, there can be achieved another excellent advantageous effect that optical fibers and the optical signal transmission core can be positioned more accurately.

Also, the fiber guide side upper clad layer 24a fills a space between the fiber guide core pattern 23a and the fiber guide side lid member portion 40a described below. Owing to this configuration, the fiber guide side lid member portion 40a can be supported by the fiber guide pattern 26. Also, because an upper end of the fiber guide pattern 26 is fixed to the fiber guide side lid member portion 40a, optical fibers can be fixed firmly by the fiber guide pattern 26.

As is shown in FIG. 2, regarding the outer two guide members 126, the fiber guide side upper clad piece 124 is present on the fiber guide core piece 123 from the top surface to the outer side surface.

The fiber guide core pattern 23a is a guide to fix optical fibers and does not function as a core for optical signal transmission.

The fiber guide side lid member portion 40a covering the fiber guide pattern 26 is present on the fiber guide pattern 26. Upper ends of the fiber guide grooves 32 are closed by the fiber guide side lid member portion 40a.

The optical waveguide side first lower clad layer 22b is present on the optical waveguide side substrate portion 10b. The optical waveguide side first lower clad layer 22b is present substantially across the entire surface of the optical waveguide side substrate portion 10b.

The optical signal transmission core pattern 23b is present on the optical waveguide side first lower clad layer 22b. As is shown in FIG. 1, the optical signal transmission core pattern 23b has a plurality (four in this embodiment) of core members 23c (FIG. 1) installed at intervals. As is shown in FIG. 1, the core members 23c as a whole extend in a long-side direction of the substrate 10. Each core member 23c is formed of a one-end portion, a center portion, and an other-end portion. The one-end portion is a portion on the side of the optical fiber guide member 2 and extends in the long-side direction of the substrate 10. An interval between the adjacent one-end portions is narrow. The center portion continues from the one-end portion and extends outward of the substrate 10 at an angle with respect to the long-side direction of the substrate 10. The other-end portion continues from the center portion and extends in the long-side direction of the substrate 10. An interval between the adjacent other-end portions is wider than the intervals between the one-end portions. In this manner, the optical waveguide 3 has a function of changing pitches of the core pattern 23b in this embodiment. Consequently, a fiber pitch of a fiber tape of optical fibers to be fixed by the optical fiber connector 1 and a pitch of optical element arrays to be set above optical path changing mirrors 31 of the optical fiber connector can be matched.

It should be noted, however, that the pitch changing function is not essential. For example, the core pattern 23b may be straight, bent in an S shape, or bent in an inverted S shape.

The optical waveguide side upper clad layer 24b is present on the optical signal transmission core pattern 23b. As is shown in FIG. 5, it is structured in such a manner that the optical signal transmission core pattern 23b is buried in the optical waveguide side upper clad layer 24b.

A V-shaped groove 30 is provided from the optical waveguide side upper clad layer 24b to the optical signal transmission core pattern 23b. The V-shaped groove 30 may extend fully in a short-side direction of the substrate 10. It is, however, sufficient for the V-shaped groove 30 to be present on at least one optical path of the optical signal transmission core pattern 23b. A refractive index of the optical signal transmission core pattern 23b and a refractive index of air are different. Hence, by utilizing a difference of the refractive indices, a surface of the V-shaped groove 30 on the side of the optical fiber guide member 2 can be used as the optical path changing mirror 31. Alternatively, as is shown in the drawing, the optical path changing mirror 31 formed of a vapor-deposited metal layer can be provided to the V-shaped groove 30 on at least the side surface on the side of the optical fiber guide member 2 of the two side surfaces.

In this embodiment, the optical path changing mirror 31 is provided to the other-end portion of the optical signal transmission core pattern 23b (core member 23c) described above. It should be appreciated, however, that the optical path changing mirror 31 may be provided to the one-end portion or the center portion. It is, however, preferable to provide the optical path changing mirror 31 to the other-end portion having a wider interval between the core members 23c from the viewpoint of avoiding reception of a signal from the adjacent core member 23c.

The optical waveguide side lid member portion 40b is present on the surface of the optical waveguide side upper clad layer 24b. The optical waveguide side lid member portion 40b serves as a reinforcement portion of the V-shaped groove 30.

As is shown in FIG. 3, a slit groove 25 is present on a boundary between the optical fiber guide member 2 and the optical waveguide 3. The slit groove 25 is present from a bottom surface of the lid member 40 to a midpoint of the substrate 10 (adhesive layer 13) in a thickness direction. It is sufficient for the slit groove 25 to be present on a boundary between at least the optical signal transmission core pattern 23b and the optical fiber guide member 2. However, the slit groove 25 may extend fully in the short-side direction of the substrate 10. In a case where the slit groove 25 is provided partially in the short-side direction of the substrate 10, the slit groove 25 can be formed suitably by laser processing. In a case where the slit groove 25 is provided fully in the short-side direction of the substrate 10, the slit groove 25 can be formed suitably by laser processing or using a dicing saw.

As is shown in FIG. 1, the fiber guide grooves 32 are present on extensions of the respective core members 23c of the optical signal transmission core patterns 23b in the optical path direction.

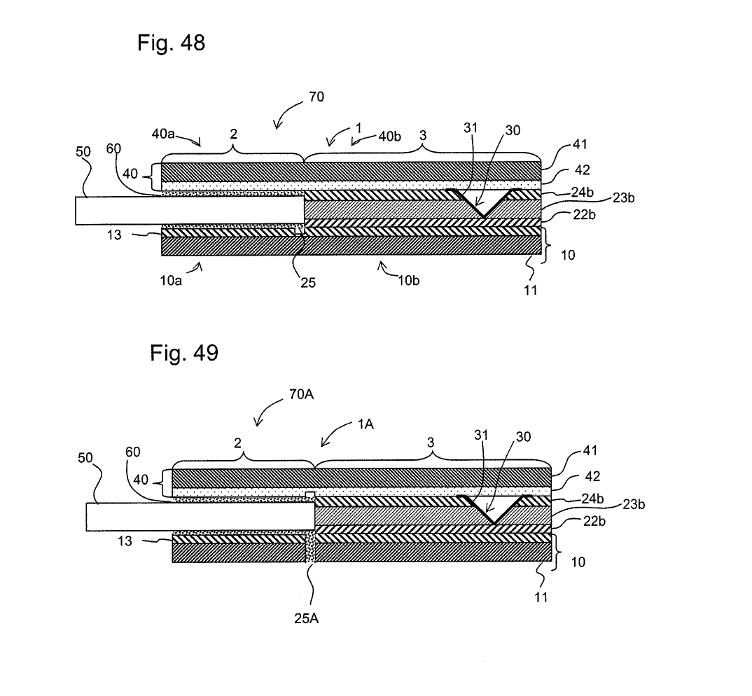

In the optical fiber connector 1 configured as above, optical fibers are inserted into the fiber guide grooves 32 until the end faces of the optical fibers come into surface contact with the end face of the optical signal transmission core pattern 23b and fixed with an adhesive (see FIG. 48 described below). The optical fibers and the optical waveguide 3 can be aligned by merely inserting the optical fibers as above.

In this instance, alignment in the width direction of the fiber guide grooves 32 (right-left direction of FIG. 6) can be performed by the fiber guide pattern 26 and alignment in the height direction of the fiber guide grooves 32 (top-bottom direction of FIG. 3) can be performed by the substrate 10 and the lid member 40. When an adhesive is introduced into the fiber guide grooves 32, clearances between the optical fibers and the substrate 10, clearances between the optical fibers and the lid member 40, and clearances between the optical fibers and the fiber guide pattern 26 are filled with the adhesive, so that axial misalignment of the optical waveguide 3 and the optical fibers can be lessened. By providing the clearances in this manner, ease of liquid flow of the adhesive can be improved.

### Method for Manufacturing Optical Fiber Connector

Hereinafter, a method for manufacturing the optical fiber connector 1 of the first embodiment will be described with reference to the drawings.

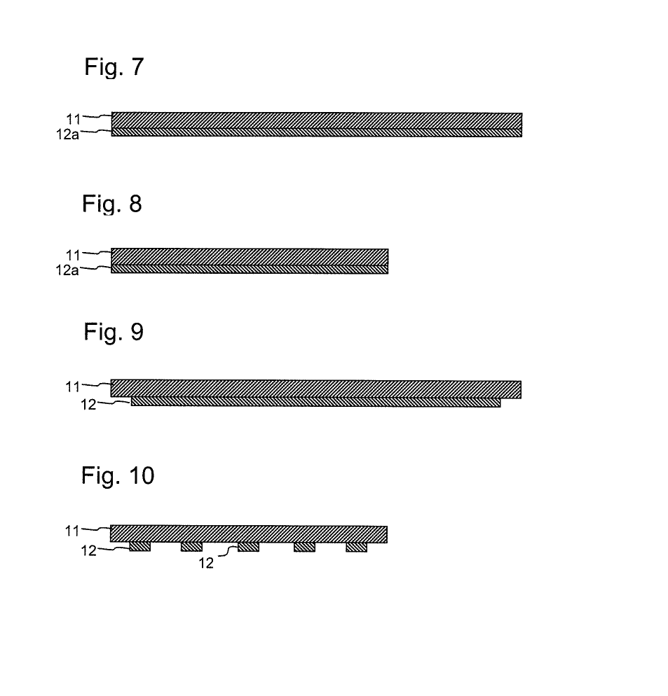

FIG. 7 is an end view taken along a line equivalent to the line A-A of FIG. 1 to show a first manufacturing process of a substrate in the optical fiber connector 1. FIG. 8 is an end view taken along a line equivalent to the line C-C of FIG. 1 to show the first manufacturing process of the substrate in the optical fiber connector 1.

FIG. 9 is an end view taken along a line equivalent to the line A-A of FIG. 1 to show a second manufacturing process of the substrate in the optical fiber connector 1. FIG. 10 is an end view taken along a line equivalent to the line C-C of FIG. 1 to show the second manufacturing processing of the substrate in the optical fiber connector 1.

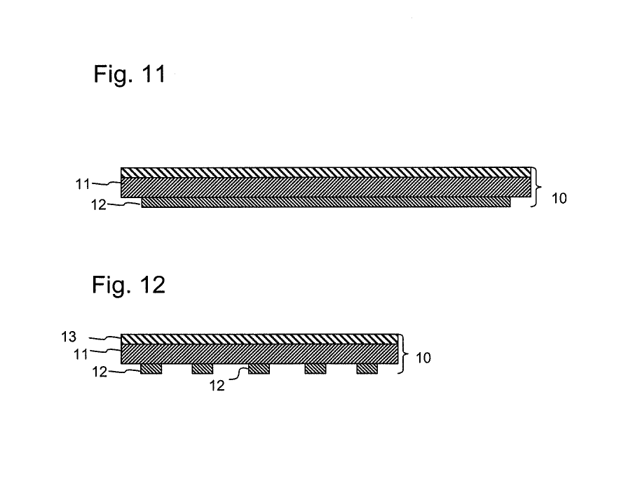

FIG. 11 is an end view taken along a line equivalent to the line A-A of FIG. 1 to show a third manufacturing process of the substrate in the optical fiber connector 1. FIG. 12 is an end view taken along a line equivalent to the line C-C of FIG. 1 to show the third manufacturing process of the substrate in the optical fiber connector 1.

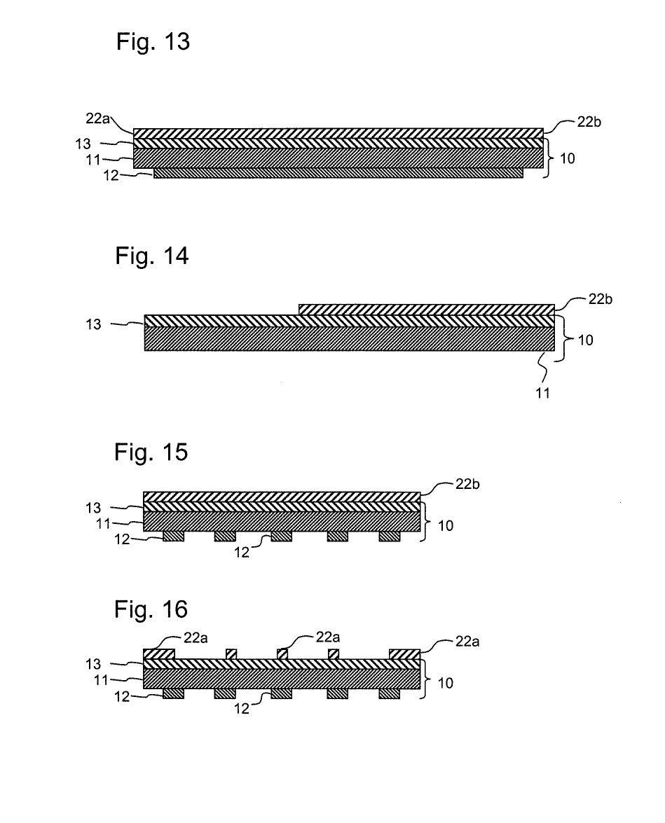

FIG. 13 is an end view taken along a line equivalent to the line A-A of FIG. 1 to show a first step of the optical fiber connector 1. FIG. 14 is an end view taken along a line equivalent to the line B-B of FIG. 1 to show the first step of the optical fiber connector 1. FIG. 15 is an end view taken along a line equivalent to the line C-C of FIG. 1 to show the first step of the optical fiber connector 1. FIG. 16 is an end view taken along a line equivalent to the line D-D of FIG. 1 to show the first step of the optical fiber connector 1.

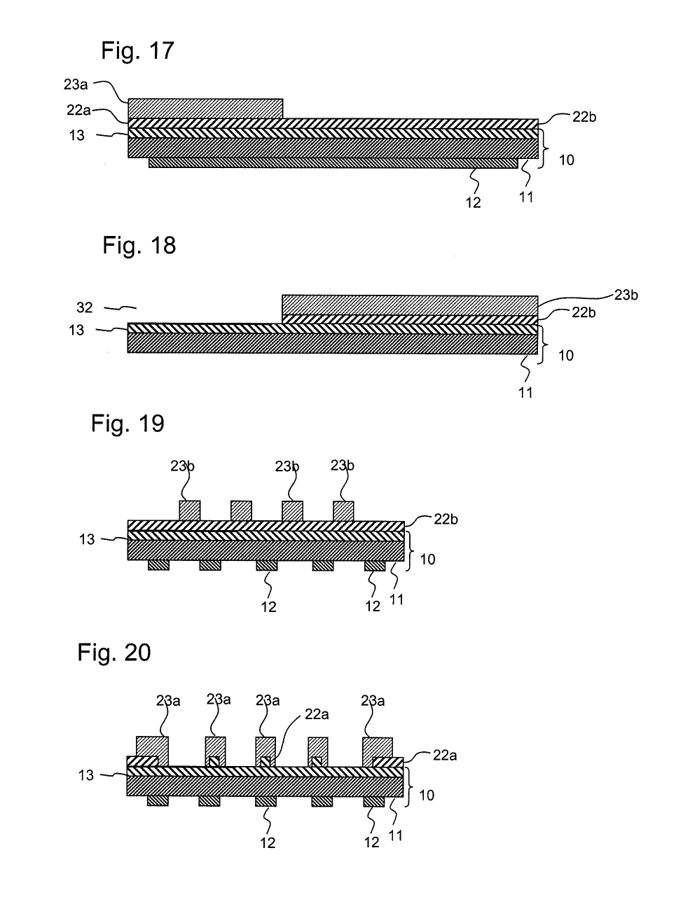

FIG. 17 is an end view taken along a line equivalent to the line A-A of FIG. 1 to show a second step of the optical fiber connector 1. FIG. 18 is an end view taken along a line equivalent to the line B-B of FIG. 1 to show the second step of the optical fiber connector 1. FIG. 19 is an end view taken along a line equivalent to the line C-C of FIG. 1 to show the second step of the optical fiber connector 1. FIG. 20 is an end view taken along a line equivalent to the line D-D of FIG. 1 to show the second step of the optical fiber connector 1.

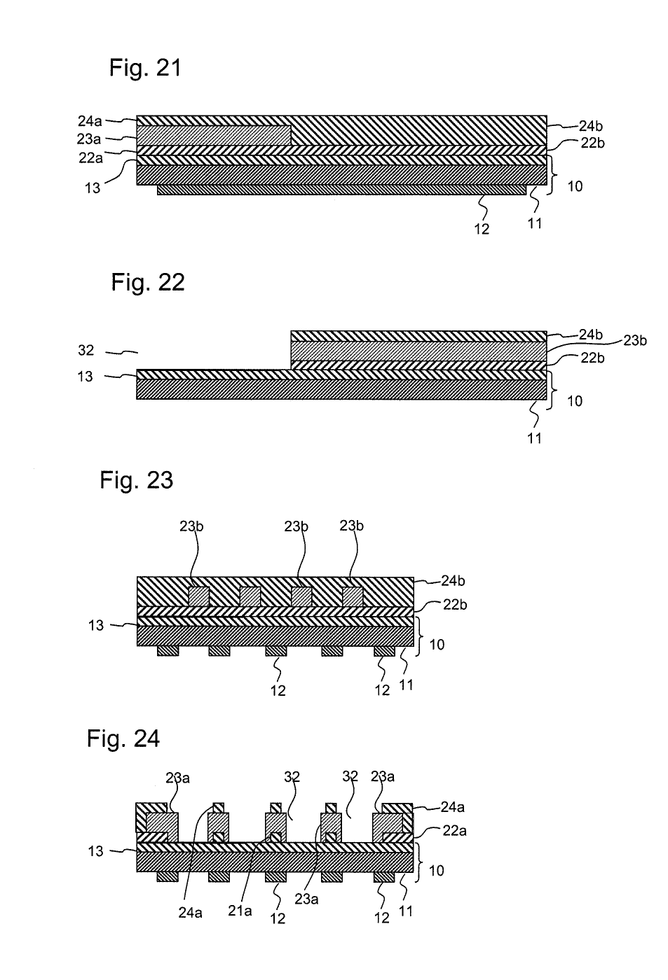

FIG. 21 is an end view taken along a line equivalent to the line A-A of FIG. 1 to show a third step of the optical fiber connector 1. FIG. 22 is an end view taken along a line equivalent to the line B-B of FIG. 1 to show the third step of the optical fiber connector 1. FIG. 23 is an end view taken along a line equivalent to the line C-C of FIG. 1 to show the third step of the optical fiber connector 1. FIG. 24 is an end view taken along a line equivalent to the line D-D of FIG. 1 to show the third step of the optical fiber connector 1.

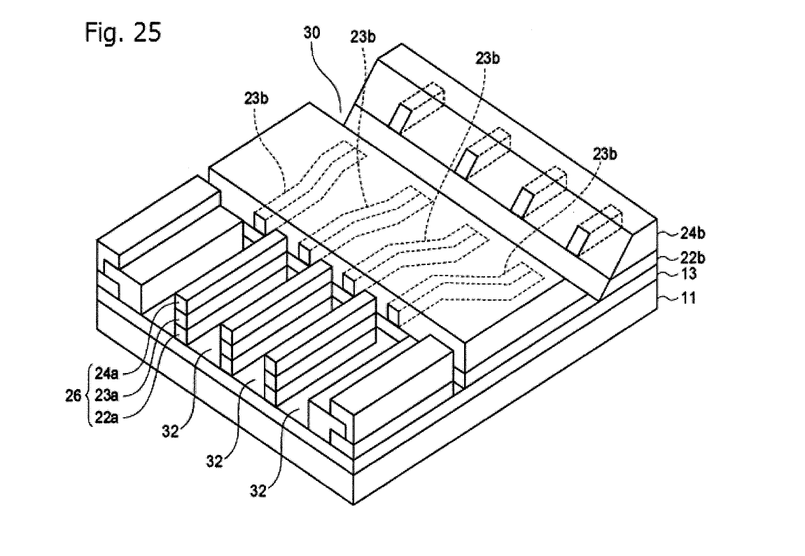

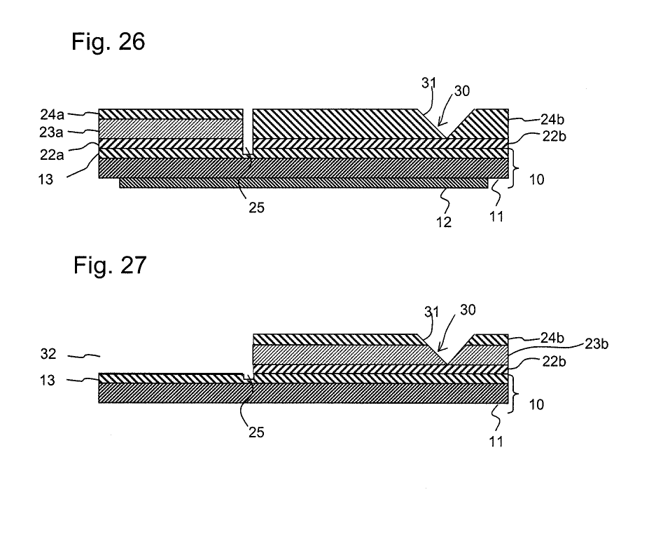

FIG. 25 is a perspective view showing a fifth step and a sixth step of the optical fiber connector 1. FIG. 26 is an end view taken along a line equivalent to the line A-A of FIG. 1 to show the fifth step and the sixth step of the optical fiber connector 1. FIG. 27 is an end view taken along a line equivalent to the line B-B of FIG. 1 to show the fifth step and the sixth step of the optical fiber connector 1.

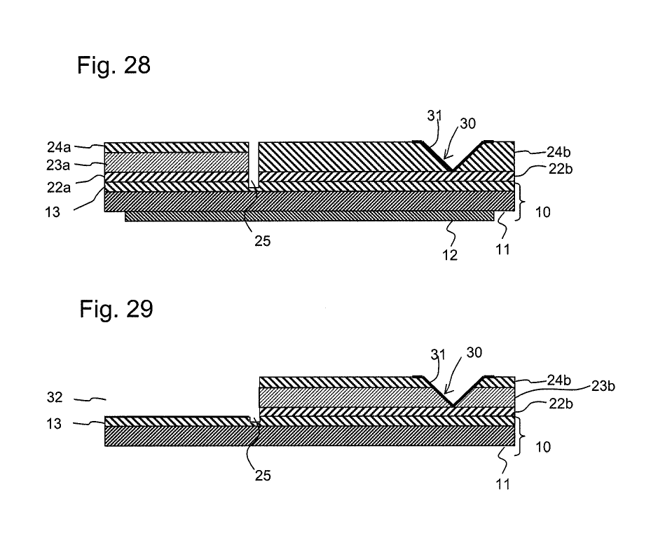

FIG. 28 is an end view taken along a line equivalent to the line A-A of FIG. 1 to show a seventh step of the optical fiber connector 1. FIG. 29 is an end view taken along a line equivalent to the line B-B of FIG. 1 to show the seventh step of the optical fiber connector 1.

The method for manufacturing an optical fiber connector of the first embodiment includes the first step, the second step, the third step, and the fourth step described below. The method may include the first manufacturing process of the substrate, the second manufacturing process of the substrate, the fifth step, the sixth step, and the seventh step described below.

### First Manufacturing Process of Substrate (FIG. 7 and FIG. 8)

In this process, a metal layer 12a is formed on the back surface of the substrate main body 11. The metal layer 12a can be formed by vapor deposition or the like.

### Second Manufacturing Process of Substrate (FIG. 9 and FIG. 10)

In this process, the metal wires 12 are formed by removing an unwanted portion from the metal layer 12a by means of etching or the like. An etching solution can be a cupric chloride aqueous solution, a ferric chloride aqueous solution, a hydrogen peroxide solution, a sulfuric acid aqueous solution, hydrochloric acid, a nitric acid aqueous solution, or the like.

### Third Manufacturing Process of Substrate (FIG. 11 and FIG. 12)

Subsequently, the adhesive layer 13 is formed on the surface of the substrate main body 11. A method of forming the adhesive layer 13 is not particularly limited and the adhesive layer 13 can be formed suitably by the same method as a first lower clad layer described below.

### First Step (FIG. 13 Through FIG. 16)

The first step is a step of forming the optical waveguide side first lower clad layer 22b by laminating the first lower clad layer on the substrate 10 and subsequently etching away the first lower clad layer present in a region in which the fiber guide grooves 32 is to be formed.

A method of forming the first lower clad layer is not particularly limited. For example, the first lower clad layer can be formed by applying a clad layer forming resin composition or laminating a clad layer forming resin film.

In the case of application, a method is not particularly limited and the clad layer forming resin composition can be applied by a common procedure. The clad layer forming resin film used for lamination can be readily manufactured, for example, by dissolving the clad layer forming resin composition in a solvent to apply the resulting solution on a carrier film and removing the solvent later. The fiber guide side first lower clad layer 22a described below can be also formed suitably by the same method as the first lower clad layer.

In this embodiment, as are shown in FIG. 14 and FIG. 16, of the entire first lower clad layer forming resin film, only the first lower clad layer forming resin film present in the region in which the fiber guide grooves 32 is to be form is etched away. Hence, the fiber guide side first lower clad layer 22a is formed on the surface of the fiber guide side substrate 10a. However, it may be alternatively configured in such a manner so as not to form the optical fiber guide member side first lower clad layer 22a by entirely removing the first lower clad layer forming resin film on the optical fiber guide member side.

### Second Step (FIG. 17 Through FIG. 20)

The second step is a step of collectively forming the fiber guide core pattern 23a and the optical signal transmission core pattern 23b by means of etching after a core forming resin layer is laminated on the substrate 10 on which the optical waveguide side first lower clad layer 22b is formed. The core forming resin layer can be formed suitably by the same method as the first lower clad layer.

### Third Step (FIG. 21 Through FIG. 24)

The third step is a step of forming the fiber guide side upper clad layer 24a, the optical waveguide side upper clad layer 24b, and the fiber guide grooves 32 by laminating an upper clad layer forming resin layer on the substrate 10 on which the fiber guide core pattern 23a and the optical signal transmission core pattern 23b are formed and subsequently etching away the upper clad layer forming resin layer present in the region in which the fiber guide grooves 32 is to be formed. The upper clad layer forming resin layer can be also formed suitably by the same method as the first lower clad layer.

### Fifth Step (FIG. 25 Through FIG. 27)

The fifth step is a step of forming the slit groove 25 on the surface of the substrate 10 along the boundary between the fiber guide grooves 32 and the optical waveguide side lower clad layer 22b. It is preferable to form the slit groove 25 using a dicing saw.

The slit groove 25 is formed chiefly for a reason as follows. That is, in FIG. 22, an optical fiber joint end face formed of end portions of the optical waveguide side first lower clad layer 22b, the optical signal transmission core patterns 23b, and the optical waveguide side upper clad layer 24b on the side of the optical fiber guide member 2 is perpendicular to the substrate 10. In practice, however, when the optical fiber joint end face is formed by means of etching or the like, the optical fiber joint end face may not be perpendicular to the substrate 10 or irregularities are generated on the optical fiber joint end face in some cases. Hence, by forming the slit groove 25 so as to make the optical fiber joint end face into a plane, the optical fiber joint end face can be a plane perpendicular to the substrate 10. When configured in this manner, the optical fiber joint end face and the optical fiber end faces come into surface contact with each other sufficiently. An optical loss at a joint point can be thus prevented or suppressed. Also, as is shown in FIG. 27, the slit groove 25 reaches the adhesive layer 13 of the substrate 10. It thus becomes possible to prevent a lower part of the end face of the optical fiber from being pushed upward by a sagging portion at the end of the optical waveguide side first lower clad layer 22b. Consequently, when the optical fiber joint end face and the optical fiber end face are joined, an optical loss at a joint point can be prevented or suppressed.

In this embodiment, the V-shaped groove 30 is formed from the optical waveguide side upper clad layer 24b so as to reach the optical signal transmission core pattern 23b in the fifth step. It is preferable to form the V-shaped groove 30 using a dicing saw.

### Sixth Step (FIG. 28 and FIG. 29)

In the sixth step, the optical path changing mirror 31 formed of a metal layer is formed in the V-shaped groove 30 on the surface on the side of the optical fiber guide member 2. The optical path changing mirror 31 can be formed suitably by evaporating metal onto the surface of the V-shaped groove 30 on the side of the optical fiber guide member 2.

### Fourth Step (FIG. 1 Through FIG. 6)

The fourth step is a step of forming the lid member 40 that covers the fiber guide grooves 32.

The lid member 40 can be formed suitably by preparing a laminated body formed of the lid member main body 41 and the adhesive layer 42 on the back surface thereof and by bonding the adhesive layer 42 to the surfaces of the fiber guide side upper clad layer 24a and the optical waveguide side upper clad layer 24b.

The lid member 40 is formed of the fiber guide side lid member portion 40a covering the fiber guide grooves 32 and the optical waveguide side lid member portion 40b covering the optical waveguide upper clad layer 24b. The optical waveguide side lid member portion 40b functions as a reinforcement member of the optical waveguide 2 in a portion in which the optical path changing mirrors 31 is to be formed.

Although a method of forming the lid member is determined appropriately depending on a material of the lid member, it is preferable to form the lid member using a roll laminator, a vacuum laminator, or the like.

### Description of Respective Members Forming Optical Fiber Connector

Hereinafter, respective members forming the optical fiber connector of the present invention will be described.

### Lower Clad Layer and Upper Clad Layer

Herein, the fiber guide side upper clad layer 24a and the optical waveguide side upper clad layer 24b are referred collectively to as the upper clad layer, the fiber guide side first lower clad layer 22a and the optical waveguide side first lower clad layer 22b are referred collectively to as the first lower clad layer, and the first lower clad layer and the adhesive layer 13 are referred collectively to as the lower clad layer in some cases.

As the lower clad layer and the upper clad layer, the clad layer forming resin or the clad layer forming resin film can be used.

A resin composition forming the clad layer forming resin film is not particularly limited as long as it is a photo- or heat-curable resin composition having a refractive index lower than that of the optical signal transmission core pattern 23b, and a heat-curable resin composition and photosensitive resin composition can be suitably used. Regarding a resin composition used for the clad layer forming resin film, it does not matter whether components contained in the resin compositions in the lower clad layer and the upper clad layer are the same or different and whether refractive indices are the same or different. In addition, it is preferable that the second lower clad layer has a function as an adhesive layer and a refractive index and a photo-curing property are not required. Hence, an adhesive or a core forming resin film described below may be used as well.

A thickness of the lower clad layer and the upper clad layer is not particularly limited. A thickness after drying is preferably in a range of 5 to 500 μm. When the thickness is 5 μm or more, a clad thickness necessary to trap light can be ensured. When the thickness is 500 μm or less, the film thickness can be readily controlled to be homogeneous. In view of the forgoing, the thickness of the lower clad layer and the upper clad layer is more preferably in a range of 10 to 100 μm. Also, in order to match a center of an optical fiber and a center of the optical signal transmission core pattern 23b, it is further preferable that the first lower clad layer uses a film having a film thickness after curing found by [(radius of optical fiber)−(thickness of optical signal transmission core pattern 23b formed on first lower clad layer 3)/2] as a film thickness.

As a concrete example, a preferable thickness of the lower clad layer when an optical fiber having an optical fiber diameter of 80 μm and an optical fiber core diameter of 50 μm is used will be described. Firstly, regarding the core diameter of the respective core members 23c forming the optical signal transmission core pattern 23b, in a case where an optical signal propagates from the optical fiber to the optical signal transmission core pattern 23b, a square circumscribed to the core diameter of the optical fiber can propagate the optical signal without an optical loss. In this case, the core members 23c have a dimension of 50 μm×50 μm (core height: 50 μm). In accordance with the equation above, an optimal thickness of the lower clad layer can be found to be 15 μm. In a case where the optical fiber same as above is used and an optical signal propagates from the optical fiber to the optical signal transmission core pattern 23b, a square inscribed to the core diameter of the optical fiber can propagate the optical signal without an optical loss. In this case, the core members 23c have a dimension of 25√2 μm×25√2 μm (core height: 25√2 μm). In accordance with the equation above, an optimal thickness of the lower clad layer can be found to be (40−25√2) μm.

Also, a thickness of the upper clad layer to bury the optical signal transmission core pattern 23b in the optical waveguide 3 is preferably as thick as or thicker than a thickness of the optical signal transmission core pattern 23b. However, the thickness can be adjusted as needed so that a height from the surface of the substrate 10 to the top surface of the upper clad layer becomes equal to or greater than the diameter of the optical fiber.

### Core Layer Forming Resin and Core Layer Forming Resin Film

Herein, the fiber guide core pattern 23a and the optical signal transmission core pattern 23b are referred collectively to as the core pattern and those in a state before the core patterns are formed by means of etching are referred to as the core layer in some cases.

In the present invention, a method of forming the core pattern is not particularly limited. For example, the core pattern can be formed by etching the core layer formed by applying the core layer forming resin or laminating the core layer forming resin film.

In the present invention, the optical fiber connector 1 can be manufactured efficiently by forming the core layer in each of the optical waveguide 3 and the optical fiber guide member 2 and by simultaneously forming the optical signal transmission core pattern 23b and the fiber guide core pattern 23a by means of simultaneously etching.

It is preferable that the core layer forming resin, in particular, the core layer forming resin used for the optical signal transmission core pattern 23b is designed to have a refractive index higher than that of the clad layer and uses a resin composition capable of forming the core pattern with an active light ray. A method of forming the core layer before patterning is not particularly limited and an example can be a method of applying the core layer forming resin composition by a normal procedure.

A thickness of the core layer forming resin film is not particularly limited and the thickness is adjusted so that a thickness of the dried core layer is normally in a range of 10 to 100 μm. When the thickness of the optical signal transmission core pattern 23b in the finished film is 10 μm or more, there is an advantage that an alignment tolerance can be increased when coupled to light receiving and emitting elements or optical fibers after the optical waveguide 3 is formed. When the thickness is 100 μm or less, there is an advantage that a coupling efficiency is enhanced when coupled to light receiving and emitting elements or optical fibers after the optical waveguide 3 is formed. In view of the foregoing, it is further preferable that the thickness of the film is in a range of 30 to 90 μm and the thickness of the film can be adjusted as needed to obtain the thickness in the range specified above.

In a case where light is transmitted from the optical fiber to the optical signal transmission core pattern 23b, an optical loss is small when a thickness after curing of the optical signal transmission core pattern 23b is equal to or greater than the core diameter of the optical fiber. In a case where light is transmitted from the optical signal transmission core pattern 23b to the optical fiber, it is further preferable to adjust in such a manner that a rectangle formed of a thickness and a width of the optical signal transmission core pattern 23b is on the inner side of the core diameter of the optical fiber.

### Substrate

A material of the substrate 10 is not particularly limited and examples include but not limited to a glass epoxy resin substrate, a ceramic substrate, a glass substrate, a silicon substrate, a plastic substrate, a metal substrate, a substrate with a resin layer, a substrate with a metal layer, a plastic film, a plastic film with a resin layer, a plastic film with a metal layer, and an electric wiring board.

Of these examples, a flexible optical fiber connector may be formed by using a flexible and tough base material as the substrate 10, for example, by using polyesters, such as polyethylene terephthalate, polybutylene terephthalate, and polyethylene naphthalate, polyethylene, polypropylene, polyamide, polycarbonate, polyphenylene ether, polyether sulfide, polyallylate, liquid crystal polymers, polysulfone, polyether sulfone, polyether ether ketone, polyetherimide, polyamide-imide, or polyimide. Although a thickness of the substrate 10 can be changed as needed depending on warpage and dimensional stability of the board, a preferable thickness is in a range of 10 μm to 10.0 mm. In a case where an optical signal whose optical path is changed by the optical path changing mirror passes through the substrate 10, it is preferable to use the substrate 10 transparent to a wavelength of the optical signal. It should be appreciated, however, that the optical path changing mirror can be omitted as described below and a substrate other than a transparent substrate can be used in this case.

The electric wiring board is not particularly limited, either. The electric wiring board may be an electric wiring board in which the metal wires 12 are formed on an FR-4 or a flexible wiring board in which the metal wires 12 are formed on a polyimide or polyamide film. The metal wires 12 can be formed out of the metal layer 12a.

Types of the adhesive layer 13 are not particularly limited and preferred examples include but not limited to a double-sided tape, a UV- or heat-curable adhesive, prepreg, a build-up material, and various types of adhesives used for the manufacturing of the electric wiring board. In a case where an optical signal passes through the substrate 10, it is sufficient that the adhesive layer 13 is transparent to a wavelength of the optical signal. In such a case, it is preferable to form the adhesive layer 13 using the clad layer forming resin film and the core layer forming resin film having an adhesion force to the substrate 10.

### Lid Member

The optical fiber connector 1 of the present invention has the lid member 40. In a configuration having such a lid member 40, it is crucial that both of the height and the width of the fiber guide groove 32 are equal to or greater than a diameter of an optical fiber fixed in the fiber guide groove 32. In other words, it is necessary that the height of the fiber guide groove 32 is greater than the diameter of the optical fiber and the width of the fiber guide groove 32 is greater than the diameter of the optical fiber. By satisfying this condition, the optical fiber can be readily inserted into a space defined by the fiber guide grooves 32 and the lid member 40. The optical fiber guide member 2 and the optical waveguide 3 are provided side by side so that the optical fiber inserted in a state as above joins the optical signal transmission core pattern 23b of the optical waveguide 3 at a position at which the optical fiber can transmit an optical signal to the optical signal transmission core pattern 23b.

A material of the lid member 40 is not particularly limited. In a case where the upper clad layer has an adhesive property, examples include but not limited to a glass epoxy resin substrate, a ceramic substrate, a glass substrate, a silicon substrate, a plastic substrate, a metal substrate, and a plastic film. A resin layer or a metal layer may be provided to these substrates. Alternatively, the electric wiring board may be used as the lid member 40.

In particular, preferred examples of the flexible and tough lid member 40 include but not limited to polyesters, such as polyethylene terephthalate, polybutylene terephthalate, and polyethylene naphthalate, polyethylene, polypropylene, polyamide, polycarbonate, polyphenylene ether, polyether sulfide, polyallylate, liquid crystal polymers, polysulfone, polyether sulfone, polyether ether ketone, polyetherimide, polyamide-imide, and polyimide. Of these examples, polyamide-imide and polyimide are particularly preferable in terms of heat resistance and dimensional stability.

In a case where the upper clad layer does not have an adhesive property, it is preferable to form the lid member 40 with an adhesive layer by providing the adhesive layer 42 to the lid body main body 41, examples of which are specified above.

Although a thickness of the lid member 40 can be changed as needed depending on warpage and dimensional stability of the board, a preferable thickness is in a range of 10 μm to 10.0 mm. A preferable range of a thickness of the adhesive layer 42 provided to the lid member 40 is normally from 0.1 μm to 50 μm, and a range of 0.1 μm to 20 μm is further preferable. When the thickness of the adhesive layer 42 is 20 μm or less, flowing of the adhesive into the fiber guide groove 32 can be suppressed, which makes it easy to control a distance from the surface of the substrate 10 to the bottom surface of the lid member 40.

Further, it is preferable that the optical waveguide 3 of the present invention has the optical path changing mirror 31. In such a case, it is preferable that the lid member 40 also serves as a reinforcement portion of the optical path changing mirror 31.

### Adhesive

An adhesive filled in the fiber guide groove 32 and used to bond an optical fiber and the optical fiber guide member 2 is not particularly limited as long as it is an adhesive capable of boding the optical fiber and the optical fiber guide member 2. Examples include but not limited to photo-curable adhesives, such as an optical adhesive, an optical path coupling adhesive, an optical component seal material, a transparent adhesive, a refractive index matching material-cum-adhesive, a clad layer forming resin varnish, and a core layer forming resin varnish, a heat-curable adhesive, a photothermal-curable adhesive, and a two-liquid mixture-curable adhesive. Of these examples, in a case where the substrate 10 and the lid member 40 do not transmit an electromagnetic wave to cure the adhesive, a heat-curable adhesive or a two-liquid mixture-curable adhesive is preferable.

### Modification of First Embodiment

More than one lower clad layer and upper clad layer may be formed to obtain a desired thickness.

In the optical fiber connector 1 described above, the optical path changing mirror 31 is an optical path changing mirror provided with the metal film. However, an optical path changing mirror using a difference of refractive indices between an air layer and the core layer is also available.

Also, the V-shaped groove 30 and the optical path changing mirror 31 may be omitted.

Particularly, in a case where the substrate main body 11 has adhesiveness, the adhesive layer 13 of the substrate 10 may be omitted. The adhesive layer 13 may form part of the lower clad layer as the second lower clad layer.

In the optical fiber connector 1 described above, the fiber guide side first lower clad layer 22a is present on the substrate 10, on top of which the fiber guide core pattern 23a is present, and on top of which the fiber guide side upper clad layer 24a is present. However, the fiber guide side first lower clad layer 22a may be omitted.

### Second Embodiment

### Structure of Optical Fiber Connector

An optical fiber connector of a second embodiment is the optical fiber connector of the first embodiment above having an adhesive introduction slit that allows an outside of the optical fiber guide member 2 and the fiber guide grooves 32 to communicate instead of the slit groove 25 or in addition to the slit groove 25.

In the optical fiber connector of the second embodiment, the fiber guide groove 32 communicates with the outside via an optical fiber insertion opening of the fiber guide groove 32 and also communicates with the outside via the adhesive introduction slit. Hence, when the adhesive is introduced from one of the optical fiber insertion opening and the adhesive introduction slit, air inside the fiber guide groove 32 flows out from the other one of the optical fiber insertion opening and the adhesive introduction slit. The adhesive can be therefore readily introduced into the fiber guide groove 32. When the optical fiber is fixed by introducing the adhesive and the optical fiber into the fiber guide groove 32 in which the adhesive is introduced, extra adhesive flows out to the outside of the fiber guide groove 32 via the adhesive introduction slit. Consequently, the optical fiber can be readily introduced into the fiber guide groove 32 and fixed therein.

### First Preferred Example of Optical Fiber Connector of Second Embodiment and Method for Manufacturing Optical Fiber Connector

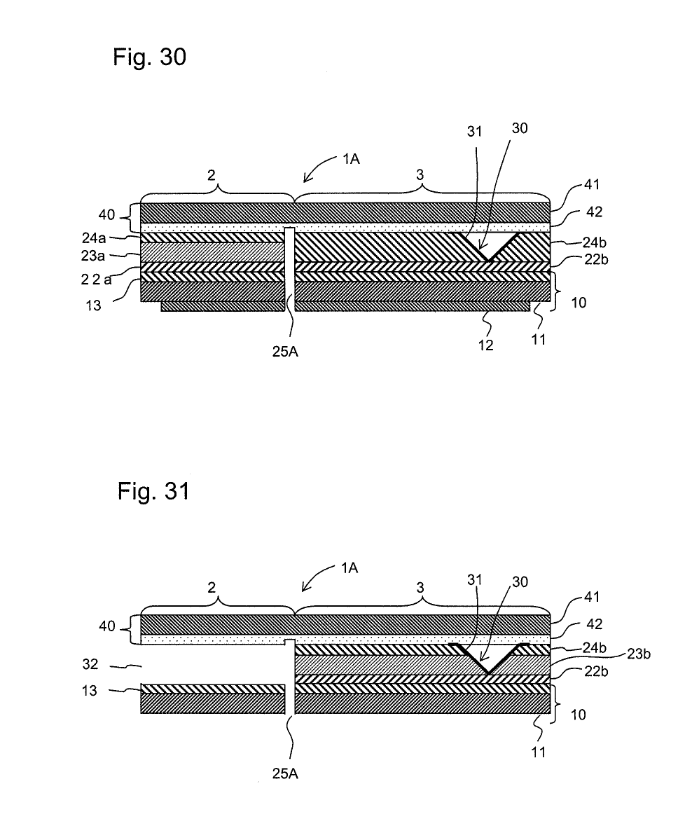

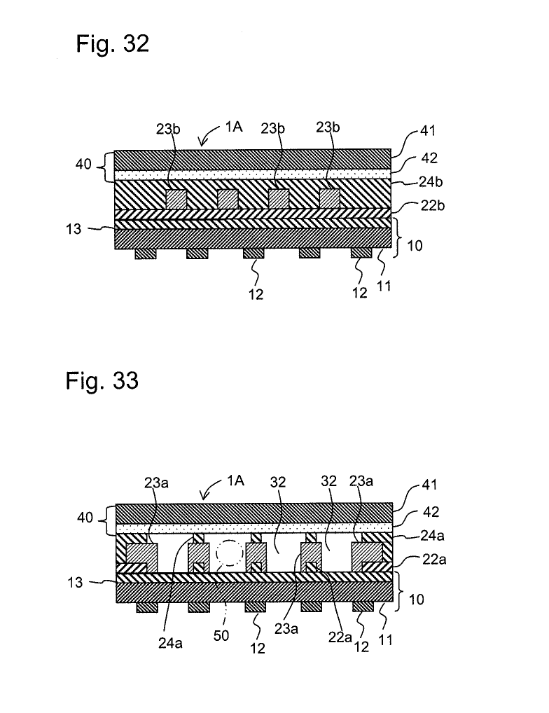

Hereinafter, a first preferred example of an optical fiber connector of the second embodiment will be described with reference to the drawings. FIG. 30 is an end view of an optical fiber connector 1A taken along a line equivalent to the line A-A of FIG. 1. FIG. 31 is an end view of the optical fiber connector 1A taken along a line equivalent to the line B-B of FIG. 1. FIG. 32 is an end view of the optical fiber connector 1A taken along a line equivalent to the line C-C of FIG. 1. FIG. 33 is an end view of the optical fiber connector 1A taken along a line equivalent to the line D-D of FIG. 1.

### Structure of Optical Fiber Connector

The optical fiber connector 1A is the optical fiber connector 1 of the first embodiment above provided with an adhesive introduction slit 25A that allows the outside of the optical fiber guide member 2 and the fiber guide grooves 32 to communicate instead of the slit groove 25.

Of the optical fiber connector 1A, same reference numerals denote same portions in the optical fiber connector 1.

The adhesive introduction slit 25A is present on the boundary between the optical fiber guide member 2 and the optical waveguide 3. The adhesive introduction slit 25A reaches the back surface of the substrate 10 from a midpoint of the adhesive layer 42 of the lid member 40 in the thickness direction. The adhesive introduction slit 25A extends fully in the short-side direction of the substrate 10. However, the adhesive introduction slit 25A may be present partially in the short-side direction.

### Method for Manufacturing Optical Fiber Connector

A method for manufacturing the optical fiber connector of the second embodiment can be suitably performed in the same manner as the method for manufacturing the optical fiber connector of the first embodiment above up to the third step. Hence, a step after the third step will be described.

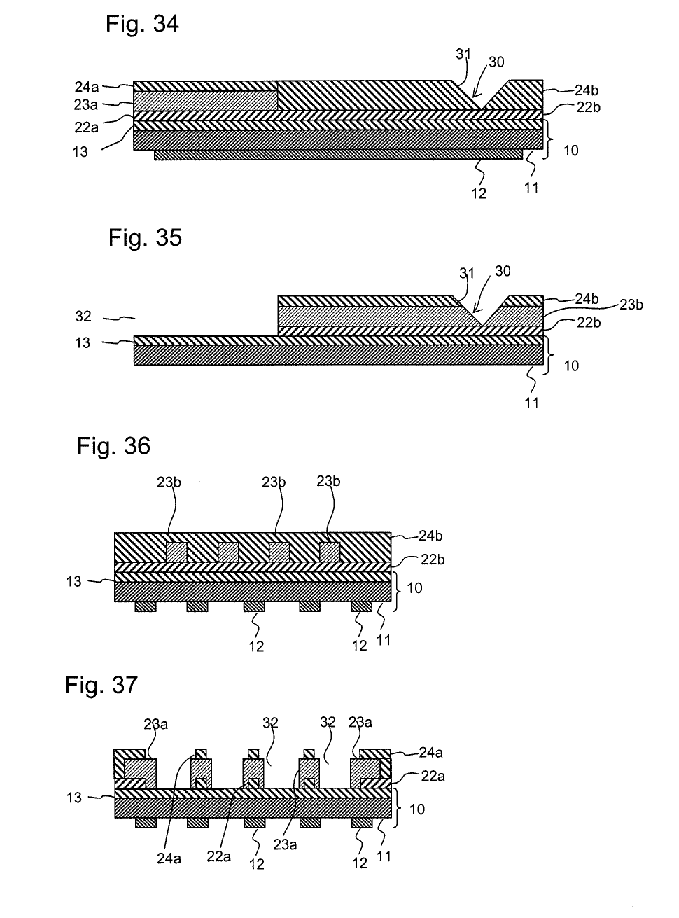

### Fifth-A Step (FIG. 34 Through FIG. 37)

FIG. 34 is an end view taken along a line equivalent to the line A-A of FIG. 1 to show a fifth-A step. FIG. 35 is an end view taken along a line equivalent to the line B-B of FIG. 1 to show the fifth-A step. FIG. 36 is an end view taken along a line equivalent to the line C-C of FIG. 1 to show the fifth-A step. FIG. 37 is an end view taken along a line equivalent to the line D-D of FIG. 1 to show the fifth-A step.

In the fifth-A step, a step same as the fifth step described above is performed except that the slit groove 25 is not formed.

In other words, in the fifth-A step, the V-shaped groove 30 reaching the optical signal transmission core pattern 23b from the optical waveguide side upper clad layer 24b is formed. It is preferable to form the V-shaped groove 30 using a dicing saw.

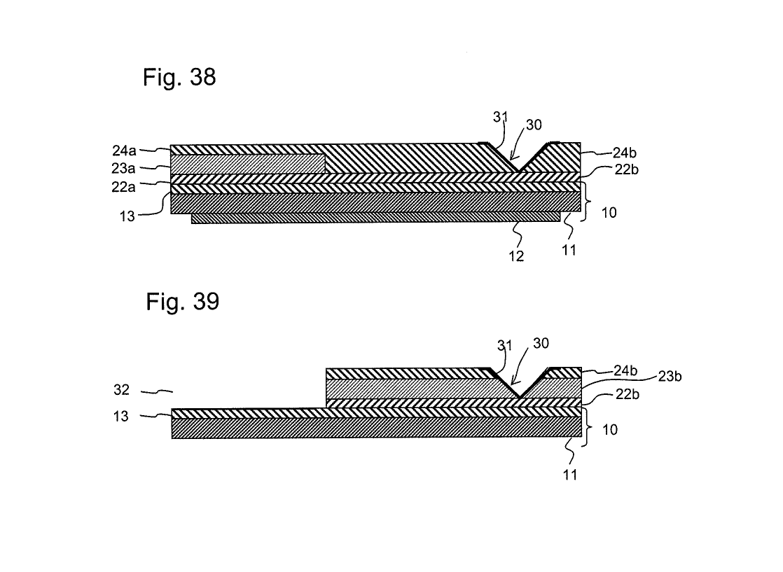

### Sixth Step (FIG. 38 and FIG. 39)

FIG. 38 is an end view taken along a line equivalent to the line A-A of FIG. 1 to show a sixth step. FIG. 39 is an end view taken along a line equivalent to the line B-B of FIG. 1 to show the sixth step.

The sixth step is the same as the sixth step of the second embodiment.

More specifically, the optical path changing mirror 31 formed of a metal layer is formed in the V-shaped groove 30 on the surface on the side of the optical fiber guide member 2. The optical path changing mirror 31 can be formed suitably by vapor-depositing metal on the surface of the V-shaped groove 30 on the side of the optical fiber guide member 2.

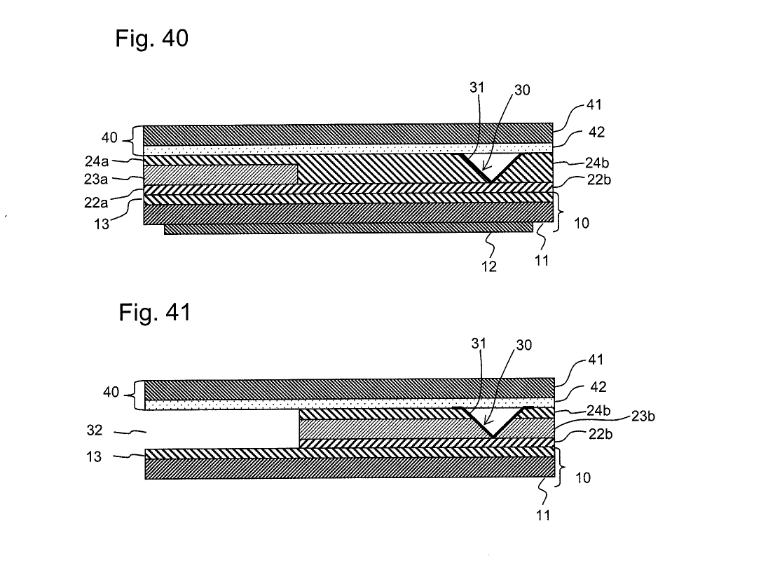

### Fourth Step (FIG. 40 Through FIG. 43)

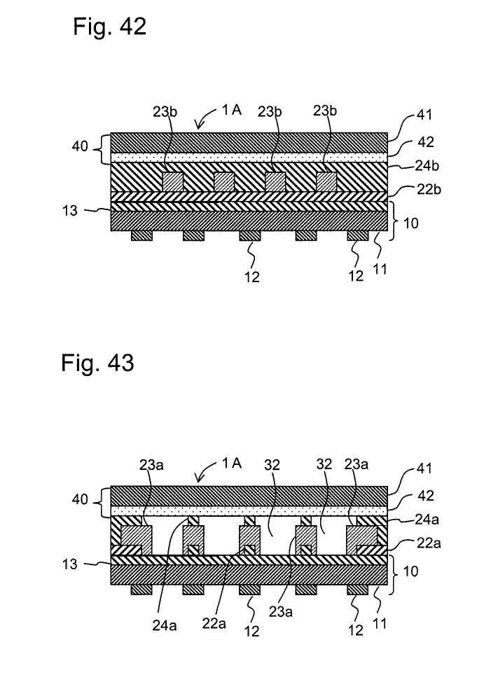

FIG. 40 is an end view taken along a line equivalent to the line A-A of FIG. 1 to show a fourth step. FIG. 41 is an end view taken along a line equivalent to the line B-B of FIG. 1 to show the fourth step. FIG. 42 is an end view taken along a line equivalent to the line C-C of FIG. 1 to show the fourth step. FIG. 43 is an end view taken along a line equivalent to the line D-D of FIG. 1 to show the fourth step.

The fourth step is the same as the fourth step of the second embodiment.

In other words, the lid member 40 covering the fiber guide grooves 32 is formed in the fourth step.

The lid member 40 can be formed suitably by preparing a laminated body formed of the lid member main body 41 and the adhesive layer 42 on the back surface thereof and by bonding the adhesive layer 42 to the surfaces of the fiber guide side upper clad layer 24a and the optical waveguide side upper clad layer 24b.

The lid member 40 is formed of the fiber guide side lid member portion 40a covering the fiber guide grooves 32 and the optical waveguide side lid member portion 40b covering the optical waveguide side upper clad layer 24b. The optical waveguide side lid member portion 40b functions as a reinforcement member of the optical waveguide 2 in a portion in which the optical path changing mirror 31 is to be formed.

### Step of Forming Adhesive Introduction Slit (FIG. 30 Through FIG. 33)

The adhesive introduction slit 25A is formed after the fourth step. The adhesive introduction slit 25A is provided from the bottom surface of the substrate 10 to the fiber guide groove 32. Also, the adhesive introduction slit 25A extends fully in the short-side direction of the substrate. It is preferable to form the adhesive introduction slit 25A using a dicing saw. When the adhesive introduction slit 25A is formed using a dicing saw, it is preferable to form the adhesive introduction sit 25A by cutting end faces of the optical waveguide side first lower clad layer 22b, the optical signal transmission core pattern 23b, and the optical waveguide side upper clad layer 24b on the side of the optical fiber guide member 2.

### Second Preferred Example of Optical Fiber Connector of Second Embodiment and Method for Manufacturing Optical Fiber Connector

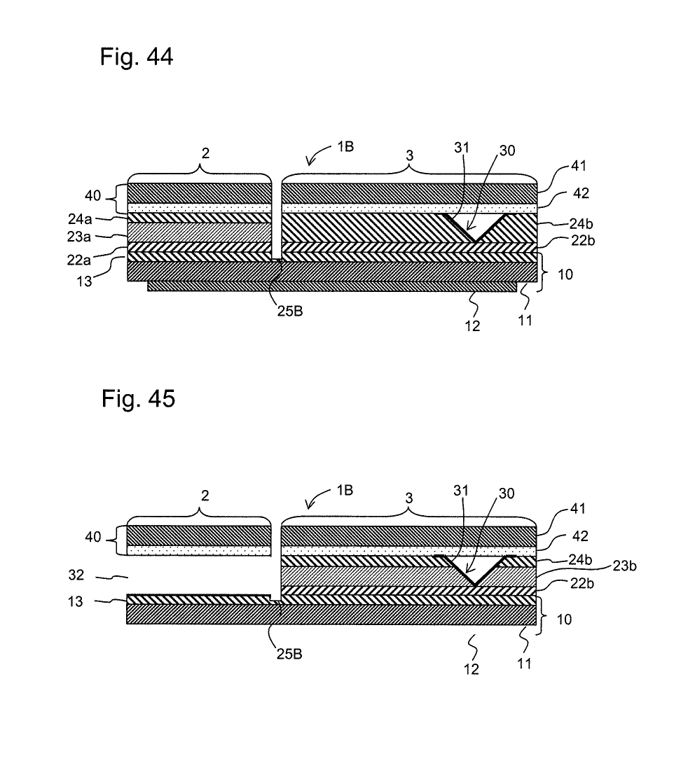

Hereinafter, a second preferred example of the optical fiber connector of the second embodiment will be described with reference to the drawings. FIG. 44 is an end view of an optical fiber connector 1B taken along a line equivalent to the line A-A of FIG. 1. FIG. 45 is an end view of the optical fiber connector 1B taken along a line equivalent to the line B-B of FIG. 1.

The optical fiber connector 1B is the optical fiber connector 1B described above provided with an adhesive introduction slit 25B that allows the outside of the optical fiber guide member 2 and the fiber guide grooves 32 to communicate instead of the adhesive introduction slit 25A.

Of the optical fiber connector 1B, same reference numerals denote same portions of the optical fiber connector 1.

The adhesive introduction slit 25B is present on the boundary between the optical fiber guide member 2 and the optical waveguide 3. The adhesive introduction slit 25B reaches the surface of the lid member 40 from a midpoint of the adhesive layer 13 of the substrate 10 in the thickness direction. The adhesive introduction slit 25B extends fully in the short-side direction of the substrate 10. However, the adhesive introduction slit 25B may be present partially in the short-side direction.

The adhesive introduction slit 25B can be also formed suitably using a dicing saw.

### Third Preferred Example of Optical Fiber Connector of Second Embodiment and Method for Manufacturing Optical Fiber Connector

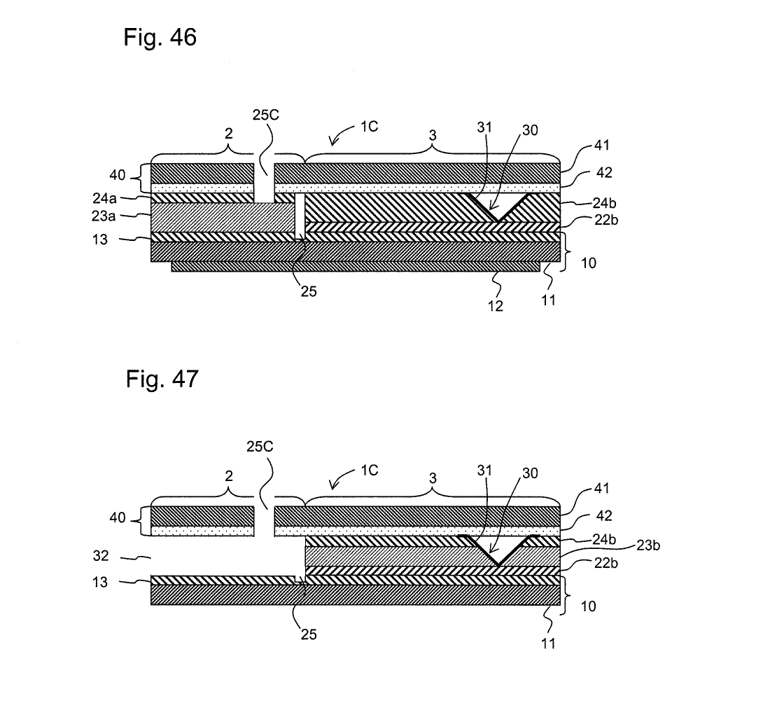

Hereinafter, a third preferred example of the optical fiber connector of the second embodiment will be described with reference to the drawings. FIG. 46 is an end view of an optical fiber connector 1C taken along a long equivalent to the line A-A of FIG. 1. FIG. 47 is an end view of the optical fiber connector 1C taken along a line equivalent to the line B-B of FIG. 1.

The optical fiber connector 1C is the optical fiber connector 1 described above further provided with an adhesive introduction slit 25C that allows the outside of the optical fiber guide member 2 and the fiber guide grooves 32 to communicate.

The adhesive introduction slit 25C is present nearer to the optical fiber guide member 2 than to the boundary between the optical fiber guide member 2 and the optical waveguide 3. The adhesive introduction slit 25C reaches the surface of the lid member 40 from a midpoint of the adhesive layer 13 of the substrate 10 in the thickness direction. The adhesive introduction slit 25C extends fully in a short-side direction of the substrate 10. However, the adhesive introduction slit 25C may be present partially in the short-side direction.

The adhesive introduction slit 25C can be also formed suitably using a dicing saw.

### Fourth Preferred Example of Optical Fiber Connector of Second Embodiment and Method for Manufacturing Optical Fiber Connector

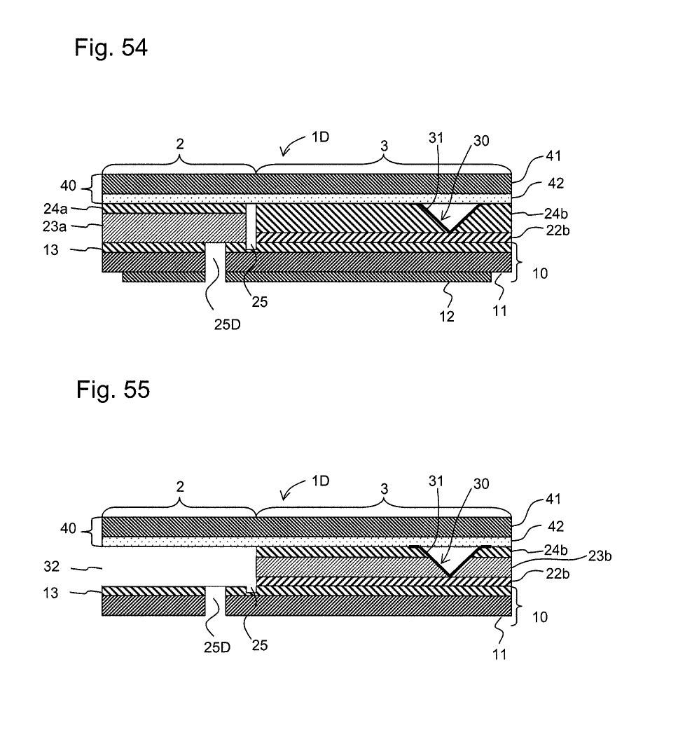

Hereinafter, a third preferred example of the optical fiber connector of the second embodiment will be described with reference to the drawings. FIG. 54 is an end view of an optical fiber connector 1D taken along a line equivalent to the line A-A of FIG. 1. FIG. 55 is an end view of the optical fiber connector 1D taken along a line equivalent to the line B-B of FIG. 1.

The optical fiber connector 1D is the optical fiber connector 1 described above further provided with an adhesive introduction slit 25D that allows the outside of the optical fiber guide member and the fiber guide grooves 32 to communicate.

The adhesive introduction slit 25D is present nearer to the optical fiber guide member 2 than to the boundary between the optical fiber guide member 2 and the optical waveguide 3. The adhesive introduction slit 25D reaches the fiber guide grooves 32 from the substrate 10. The adhesive introduction slit 25D extends fully in a short-side direction of the substrate 10. However, the adhesive introduction slit 25D may be present partially in the short-side direction.

The adhesive introduction slit 25D can be also formed suitably using a dicing saw.

### Method for Connecting Optical Fiber Connector and Optical Fiber and Assembled Body of the Present Invention

A method for connecting an optical fiber connector and an optical connector of the present invention is a connection method of filling the fiber guide groove of the optical fiber connector of the present invention with an adhesive and inserting and installing an optical fiber in the fiber guide groove.

An assembled body of an optical fiber connector and an optical fiber of the present invention has the optical fiber connector of the present invention and an optical fiber and an adhesive installed in the fiber guide groove of the optical fiber connector.

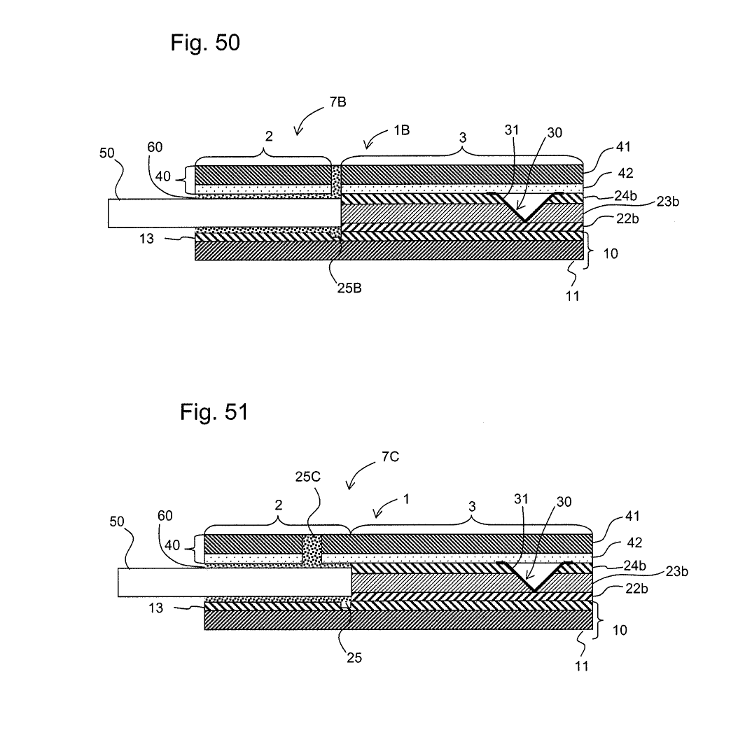

FIG. 48 through FIG. 51 are cross sections showing assembled bodies 70, 70A, 70B, and 70C of an optical fiber connector and an optical fiber and a method for connecting an optical fiber connector and an optical fiber of the present invention.

The assembled bodies 70, 70A, 70B, and 70C are formed of the optical fiber connectors 1, 1A, 1B, and 1C, respectively, and optical fibers 50 and adhesives 60 installed in the fiber guide grooves 32 of the respective fiber connectors 1, 1A, 1B, and 10. The assembled bodies 70, 70A, 70B, and 70C can be manufactured by filling the fiber guide grooves 32, respectively, of the optical fiber connectors 1, 1A, 1B, and 1C with the adhesive 60 and inserting and installing the optical fiber 50 in the fiber guide grooves 32.

The adhesive is not particularly limited as long as it can bond the optical fiber 50 and the optical fiber guide member 2. Examples include but not limited to photo-curable adhesives, such as an optical adhesive, an optical path coupling adhesive, an optical component seal material, a transparent adhesive, a refractive index matching material-cum-adhesive, a clad layer forming resin varnish, and a core layer forming resin varnish, a heat-curable adhesive, a photothermal-curable adhesive, and a two-liquid mixture-curable adhesive. Of these examples, in a case where the substrate 10 and the lid member 40 do not transmit an electromagnetic wave to cure the adhesive, a heat-curable adhesive or a two-liquid mixture-curable adhesive is preferable.

A viscosity of the adhesive at 25° C. is preferably in a range of 150 to 400 mPa·s, more preferably in a range of 200 to 350 mPa·s, and further preferably in a range of 250 to 300 mPa·s. When the viscosity is within these ranges, a center line of the optical fiber 50 can substantially match a center line of the fiber guide groove 32 in an optical fiber insertion direction. The viscosity at 25° C. can be measured by a measurement method described in respective embodiments below.

### Dimensions of Optical Fiber Connector and Optical Fiber

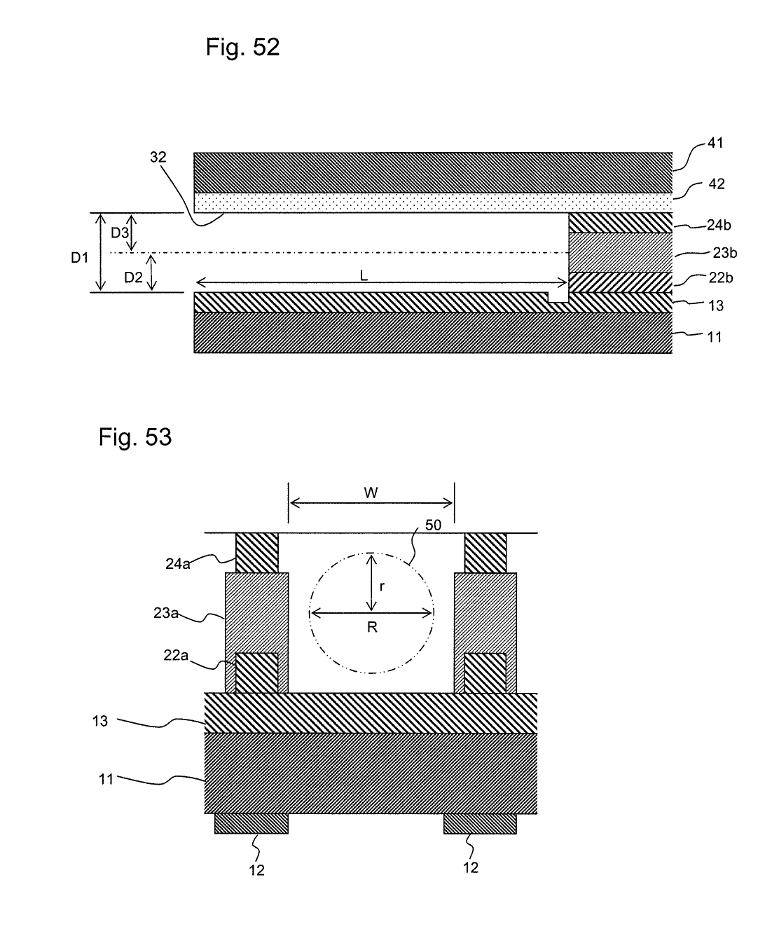

Preferred dimensions of an optical fiber connector and an optical fiber in an optical fiber connector, a method for manufacturing an optical fiber connector, a method for connecting an optical fiber connector and an optical fiber, and an assembled body of an optical fiber connector and an optical fiber of the present invention will be described using FIG. 52 and FIG. 53.

FIG. 52 and FIG. 53 are partial enlarged views of FIG. 4 and FIG. 6, respectively. The dimensions will be described using the optical fiber connector 1. However, dimensions are the same in the cases of using the optical fiber connectors 1A through 1D described below.

An optical fiber is not limited in the present invention. A term, “diameter of the optical fiber”, means a major diameter of a clad of the optical fiber. In a case where the optical fiber is inserted into the fiber guide groove while the clad is covered with a protection layer, the term means a major diameter of the optical fiber with the protection layer. Also, a term, “radius of the optical fiber”, means half the length of “the diameter of the optical fiber” defined as above.

It is preferable that the diameter of the optical fiber is 200 μm or less from the viewpoint that a film thickness of the core forming resin film can be readily controlled. It is further preferable to use an optical fiber having a diameter of 125 μm or 80 μm.

It is preferable that a width W of the fiber guide groove 32 is equal to or greater than a diameter R of the optical fiber 50 fixed to the optical fiber guide member 2 and that a height D1 of the fiber guide groove 32 is equal to or greater than the diameter R of the optical fiber. With these dimensions, the optical fiber 50 can be inserted and installed in the fiber guide groove 32 in a satisfactory manner.

It is preferable that a value α1, which is found by subtracting the radius r of the optical fiber 50 fixed to the optical fiber guide member 2 from a distance D2 between the substrate 10 and a center of the optical signal transmission core pattern 23b in a height direction, is in a range of 0.5 to 15 μm, and that a value α2, which is found by subtracting the diameter R of the optical fiber 50 from the height D1 of the fiber guide groove 32, is in a range of 1.0 to 30 μm. With these dimensions, an interval between the optical fiber 50 and the substrate 10 and an interval between the optical fiber 50 and the lid member 40 become narrower and the optical fiber 50 is located substantially at a center of the fiber guide groove 32 in the height direction due to surface tension of the adhesive and fluidity of the adhesive. Consequently, center cores of the optical fiber 50 and the optical transmission core pattern 23b can be matched with accuracy.

In view of the foregoing, the value α1 is more preferably in a range of 0.5 to 7.5 μm and further preferably in a range of 0.5 to 5 μm. Also, the value α2 is more preferably in a range of 1.0 to 15 μm and further preferably in a range of 1.0 to 10 μm.

Likewise, it is preferable that a value α3, which is found by subtracting the radius r of the optical fiber 50 fixed to the optical fiber guide member 2 from a distance D3 between a center of the optical signal transmission core pattern 23b in the height direction and the lid member 40, is preferably in a range of 0.5 to 15 μm, more preferably in a range of 0.5 to 7.5 μm, and further preferably in a range of 0.5 to 5 μm. With these dimensions, an interval between the optical fiber 50 and the substrate 10 and an interval between the optical fiber 50 and the lid member 40 become narrower and the optical fiber 50 is located substantially at a center of the fiber guide groove 32 in the height direction due to surface tension of the adhesive and fluidity of the adhesive. Consequently, center cores of the optical fiber 50 and the optical transmission core pattern 23b can be matched with accuracy.

In view of the foregoing, an absolute value α4 of a difference between the value α3 and the value α1 is preferably in a range of 0 to 7.5 μm, more preferably in a range of 0 to 5 μm, and further preferably in a range of 0 to 3 μm.

From the viewpoint of ease of mounting and a tolerance of an optical fiber, it is preferable that a value α5, which is found by subtracting the diameter R of the optical fiber from the width W of the fiber guide groove 32, is in a range of 1.0 μm to 30 μm, more preferably in a range of 1.0 to 15 μm, and further preferably in a range of 1.0 to 10 μm.

Also, it is preferable that a center line of the fiber guide groove 32 in an optical fiber insertion direction and a center line of the optical signal transmission core pattern 23b in an optical path direction coincide with each other. In a case where the optical signal transmission core pattern 23b and the fiber guide core pattern 23a are formed by means of photolithography in the same step, a photo-mask shape is designed in such a manner that the center line of the fiber guide groove 32 and the center line of the optical signal transmission core pattern 23b (core members 23c) coincide with each other. The optical fiber to be used is preferably a multi-mode optical fiber having a core diameter of at least several tens μm.

It is preferable that a length L of the fiber guide groove 32 is in a range of 100 μm to 30 mm, more preferably in a range of 300 μm to 10 mm, and further preferably in a range of 1 mm to 5 mm. When the length L is 100 μm or more, inclination of the optical fiber with respect to a direction in the length L of the fiber guide groove 32 can be prevented sufficiently. When the length L is 30 mm or less, the optical fiber connector can be more compact.

### EXAMPLES

Hereinafter, examples of the present invention will be described more in detail. It should be understood, however, that the present invention is not limited to the following examples unless the description deviates from the scope and sprit of the present invention.

### Formation of Clad Layer Forming Resin Film

### Formation of Base Polymer (A) and (Meth)Acrylic Polymer (A-1)

Herein, 46 parts by mass of propylene glycol monomethyl ether acetate and 23 parts by mass of methyl lactate were weighted in a flask provided with a stirrer, a cooling tube, a gas introduction tube, a dropping funnel, and a thermometer, and stirred with an introduction of a nitrogen gas. A liquid temperature was raised to 65° C. and a mixture of 47 parts by mass of methyl methacrylate, 33 parts by mass of butyl acrylate, 16 parts by mass of 2-hydroxy ethyl methacrylate, 14 parts by mass of methacrylic acid, 3 parts by mass of 2,2′-azobis(2,4-dimethyl valeronitrile), 46 parts by mass of propylene glycol monomethyl ether acetate, and 23 parts by mass of methyl lactate was dropped over three hours. The resulting mixture was stirred for three hours at 65° C. and further for one hour at 95° C. A solution (solid content of 45 percent by mass) of (meth)acrylic polymer (A-1) was thus obtained.

### Measurement of Weight-Average Molecular Weight

A weight-average molecular weight (in terms of standard polystyrene) of (A-1) was measured by means of GPC (using SD-8022, DP-8020, and RI-8020 available from Tosoh Corporation) and found to be 3.9×10⁴. The column used was Gelpack® GL-A150-S and Gelpack® GL-A160-S available from Hitachi Chemical Co., Ltd.

### Measurement of Acid Number

An acid number of (A-1) was measured and found to be 79 mgKOH/g. The acid number was calculated from an amount of a 0.1 mol/L aqueous solution of potassium hydroxide required to neutralize an (A-1) solution. Herein, a point at which phenolphthalein used as an indicator turned from colorless to pink was set as a neutralization point.

### Measurement of Viscosity of Adhesive

A viscosity of an adhesive was measured using an E-type viscometer (commercially known as VISCONICELD available from Toki Sangyo Co., Ltd.) for a sample of 0.4 mL at a measurement temperature of 25° C. and a rotating speed of 20 min⁻¹.

### Preparation of Clad Layer Forming Resin Varnish A

Herein, 84 parts by mass (solid content of 38 parts by mass) of the (A-1) solution (solid content of 45 percent by mass) as the base polymer (A), 33 parts by mass of urethane(meth)acrylate having a polyester skeleton (U-200AX available from Shin-Nakamura Chemical Co., Ltd.) and 15 parts by mass of urethane(meth)acrylate having a polypropylene glycol skeleton (UA-4200 available from Shin-Nakamura Chemical Co., Ltd.) as a photo-curable component (B), 20 parts by mass (solid content of 15 parts by mass) of a multifunctional blocked isocyanate solution (solid content of 75 percent by mass) prepared by protecting an isocyanurate-type trimmer of hexamethylene diisocyanate with methyl ethyl ketone oxime (Sumidur® BL3175 available from Sumika Bayer Urethane Co., Ltd.) as a heat-curable component (C), one part by mass of 1-[4-(2-hydroxyethoxy)phenyl]-2-hydroxy-2-methyl-1-propane-1-one (IRGACURE® 2959 available from Chiba Japan Co., Ltd.) and one part by mass of bis(2,4,6-trimethylbenzoyl)phenyl phosphine oxide (IRGACURE® 819 available from Chiba Japan Co., Ltd.) as a photopolymerization initiator (D), and 23 parts by mass of propylene glycol monomethyl ether acetate as a diluent organic solvent were mixed with stirring. The resulting mixture was filtered under pressure using a polyflon filter with a pore diameter of 2 μm (PF020 available from Advantec Toyo Kaisha, Ltd.) followed by defoaming under reduced pressure. A clad layer forming resin varnish A was thus obtained.

The clad layer forming resin varnish A thus obtained was applied on an untreated surface of a PET film (Cosmo Shine® A4100 with a thickness of 50 μm available from Toyobo Co., Ltd.) using a coater (Multicoater-TM-MC available from HIRANO TECSEED Co, Ltd.) and dried at 100° C. for 20 minutes. Thereafter, a PET film treated with surface mold releasing processing (Purex® A31 with a thickness of 25 μm available from Teijin DuPont Film Japan Limited) used as a protection film was laminated to the dried PET film. A clad layer forming resin film was thus obtained. A thickness of the resin layer in this instance can be adjusted arbitrarily by regulating a gap of the coater. Thicknesses of the first lower clad layer and the second lower clad layer (adhesive layer) used herein are described in respective examples. Film thicknesses after curing of the first lower clad layer and the second lower clad layer were the same as film thicknesses after coating. Film thicknesses of the upper clad layer forming resin film used in this embodiment will be described in this example, too. Assume that the film thicknesses of the upper clad layer forming resin film described in the examples are film thicknesses after coating.

### Formation of Core Layer Forming Resin Film

A core layer forming resin varnish B was prepared by the same method and under the same conditions as the manufacturing example of the clad layer forming resin varnish A described above except that 26 parts by mass of phenoxy resin (Pheno Tohto® YP-70 available from Tohto Kasei Co., Ltd.) as a base polymer (A), 36 parts by mass of 9,9-bis[4-(2-acryloyloxyethoxy)phenyl]fluorene (commercially known as A-BPEF available from Shin-Nakamura Chemical Co., Ltd.) and 36 parts by mass of bisphenol A type epoxy acrylate (commercially known as EA-1020 available from Shin-Nakamura Chemical Co., Ltd.) as a photopolymerized compound (B), one part by mass of bis(2,4,6-trimethylbenzoyl)phenyl phosphine oxide (commercially known as IRGACURE® 819 available from Chiba Japan Co., Ltd.) and one part by mass of 1-[4-(2-hydroxyethoxy)phenyl]-2-hydorxy-2-methyl-1-propane-1-one (commercially known as IRGACURE® 2959 available from Chiba Japan Co., Ltd.) as a photopolymerization initiator (C), and 40 parts by mass of propylene glycol monomethyl ether acetate as an organic solvent were used. Thereafter, the resulting mixture was filtered under pressure followed by defoaming under reduced pressure by the same method and under the same condition as the manufacturing example of the clad layer forming resin varnish A described above.

The core layer forming resin varnish B thus obtained was applied on an untreated surface of a PET film (commercially known as Cosmo Shine® A1517 with a thickness of 16 μm available from Toyobo Co., Ltd.) and dried by the same method as the manufacturing example described above. Subsequently, a mold releasing PET film (commercially known as Purex® A31 with a thickness of 25 μm available from Teijin DuPont Film Co., Ltd.) used as a protection film was laminated to the dried PET film so that the mold releasing surface was on the resin side. A core layer forming resin film was thus obtained. A thickness of the resin layer in this instance can be adjusted arbitrarily by regulating a gap of the coater. Thicknesses of the core layer forming resin film used herein are described in respective examples. Assume that the film thicknesses of the core layer forming resin film described in the examples are film thicknesses after coating.

### Formation of Substrate

### Formation of Electric Wires by Subtractive Method

A photo-sensitive dry film resist (commercially known as Photec® with a thickness of 25 μm available from Hitachi Chemical Co., Ltd.) was laminated to a copper foil surface of a polyimide film having copper foil as a metal layer on one surface ((polyimide: UPILEX® VT with a thickness of 25 μm available from Ube-Nitto Kasei Co., Ltd.) and (copper foil: NA-DFF with a thickness of 9 μm available from Mitsui Mining & Smelting Co., Ltd.)) using a roll laminator (HLM-1500 available from Hitachi Chemical Techno-Plant Co., Ltd.) under the following conditions: at a pressure of 0.4 MPa and a temperature of 110° C. and a lamination speed of 0.4 m/min. Subsequently, 120 mJ/cm² of an ultraviolet ray (wavelength of 365 nm) was irradiated to the resulting film from the photosensitive dry film resist side using an UV exposure device (EXM-1172 available from ORC Manufacturing Co., Ltd.) via a 50-μm-wide negative photomask and an unexposed portion of the photosensitive dry film resist was removed using a 0.1 to 5%-by-mass dilute solution of sodium carbonate at 35° C. Subsequently, the copper foil in an exposed portion of the film due to removal of the photosensitive dry film resist was etched away using a ferric chloride solution. The photosensitive dry film resist in the exposed portion was removed using a 1 to 10%-by-mass aqueous solution of sodium hydroxide at 35° C. Electric wires with L (line width)/S (clearance width)=60/65 μm were thus formed and consequently a flexible wiring board was obtained.

### Formation of Ni/Au Plating

Thereafter, the flexible wiring board was subjected to degreasing and soft etching and rinsed with acid. Subsequently, the flexible wiring board was immersed in an electroless Ni plating sensitizer (commercially known as SA-100 available from Hitachi Chemical, Co., Ltd.) at 25° C. for five minutes and rinsed with water. Subsequently, a 3-μm-thick Ni coating was formed by immersing the flexible wiring board in an electroless Ni plating liquid (ICP Nicoron® GM-SD solution with a pH of 4.6 available from OKUNO Chemical Industries Co., Ltd.) at 83° C. for eight minutes, followed by rinsing with pure water.

Subsequently, the flexible wiring board was immersed in an immersion gold plating liquid (prepared using 100 mL of HGS-500 and 1.5 g of gold potassium cyanide/L) (commercially known as HGS-500 available from Hitachi Chemical Co., Ltd.) at 85° C. for eight minutes. A 0.06-μm-thick immersion gold coating was thus formed on the Ni coating. A flexible wiring board in which a portion of the electric wires without a coverlay film was coated with Ni and Au plating was thus obtained.

The 10-μm-thick clad layer forming resin film obtained as the adhesive layer 13 as described above was cut into a size of 100×100 mm and the mold releasing PET film (Purex® A31) used as the protection film was peeled off. The resulting film was heated and press-fit to the polyimide surface of the flexible wiring board formed as above under the following conditions: at a pressure of 0.4 MPa and a temperature of 100° C. for a pressuring time of 30 seconds, after vacuuming to 500 Pa or below using a vacuum pressuring laminator (MVLP-500 available from Meiki Co., Ltd.) as a flat-plate laminator. An electric wiring board with the second lower clad layer was thus formed. Subsequently, 4 J/cm² of an ultraviolet ray (wavelength of 365 nm) was irradiated to the electric wiring board from the carrier film side using an UV exposure device (EXM-1172 available from Manufacturing Co., Ltd.) and the carrier film was peeled off. The electric wiring board was then heated at 170° C. for one hour. The substrate 10 with the 10-μm-thick second lower clad layer was thus formed.

### Example 1

### Manufacturing of Optical Fiber Connector 1A

### First Step

The 20-μm-thick lower clad layer forming resin film obtained as above was cut into a size of 100×100 μm and the protection film was peeled off. The resulting film was laminated on the second lower clad layer surface side using a vacuum laminator under the same conditions as above. Subsequently, 250 mJ/cm² of an ultraviolet ray (wavelength of 365 nm) was irradiated to the resulting film using an UV exposure device (EXM-1172 available from ORC Manufacturing Co., Ltd.) from the carrier film side via a negative photomask having four unexposed portions, each measuring 95 μm×3.0 mm. Thereafter, the carrier film was peeled off and the first lower clad layer was etched away using a developer (1% aqueous solution of potassium carbonate). Subsequently, the resulting film was rinsed with water and dried and cured by heating at 170° C. for one hour. Openings, each measuring 95 μm×3.0 mm, were thus formed in a portion in which the fiber guide grooves is to be formed. Consequently, the optical waveguide side first lower clad layer 22b was formed in a portion in which the optical waveguide 3 is to be formed and the fiber guide side first lower clad layer 22a was formed on the side of the optical fiber guide member 2.

### Second Step

Subsequently, the 50-μm-thick core layer forming resin film, from which the protection film was peeled off, was laminated on the first lower clad layer surface using a roll laminator (HLM-1500 available from Hitachi Chemical Techno-Plant Co., Ltd.) under the following conditions: at a pressure of 0.4 MPa, a temperature of 50° C., and a lamination speed of 0.2 m/min. Subsequently, the core layer forming resin film was heated and press-fit to the first lower clad layer surface under the following conditions: at a pressure of 0.4 MPa and a temperature of 70° C. for a pressuring time of 30 seconds, after vacuuming to 500 Pa or below using the vacuum pressurizing laminator (MVLP-500 available from Meiki Manufacturing Co., Ltd.). Thereafter, 700 mJ/cm² of an ultraviolet ray (wavelength of 365 nm) was irradiated to the resulting film using the UV exposure device via a negative photomask having an optical signal transmission core pattern width of 50 μm (pattern pitch of optical fiber connection portions: 125 μm, and pattern pitch of optical path changing mirror forming portions (points 5 mm away from the optical fiber connection portions): 250 μm for four core members) and a fiber guide core pattern width of 40 μm (fiber groove pitch: 125 μm for four guide members and 150 μm for guide members at both ends of the fiber guide core pattern) after alignment for the optical signal transmission core pattern 23b to be formed on the first lower clad layer and for the fiber guide grooves 32 formed by the fiber guide core pattern 23a to be formed on the substrate. Subsequently, the resulting film was heated at 80° C. for five minutes after exposure. Thereafter, the PET film used as the carrier film was peeled off and the core pattern was etched using a developer (propylene glycol monoethyl ether acetate/N,N-dimethyl acetamide=8/2, ratio by mass). Subsequently, the resulting film was rinsed with a rinse solution (isopropanol) and dried by heating at 100° C. for ten minutes. The optical signal transmission core pattern 23b and the fiber guide core pattern 23a were thus formed and the 85-μm-wide fiber guide grooves 32 were formed at the same time. A size of each pattern of the fiber guide core pattern 23a is designed so that, when an optical fiber is fixed in the fiber guide groove 32, the optical fiber joins the optical signal transmission core pattern 23b at a position at which the optical fiber can transmit an optical signal to and receive an optical signal from the fiber guide core pattern 23a.

### Third Step

Subsequently, the 70-μm-thick upper clad layer resin film, from which the protection film was peeled off, was laminated to the resulting film from the core pattern forming surface side by heating and press-fitting under the following conditions: at a pressure of 0.35 MPa and a temperature of 110° C. for a pressuring time of 30 seconds after vacuuming to 500 Pa or below using the vacuum pressuring laminator (MVLP-500 available from Meiki Manufacturing Co., Ltd.). Further, after 150 mJ/cm² of an ultraviolet ray (wavelength of 365 nm) was irradiated to the resulting film using the negative photomask used when the first lower clad layer was formed, the carrier film was peeled off. Then, the upper clad layer forming resin film was etched using a developer (1% aqueous solution of potassium carbonate). Subsequently, the resulting film was rinsed with water and dried and cured by heating at 170° for one hour.

In the manner as described above, a four-channel fiber connector main body with the pitch of 125 μm and the fiber diameter of 80 μm was manufactured.

In the optical fiber connector main body thus obtained, a width of the fiber guide grooves 32 was 85 μm, a height of the fiber guide core pattern 23a (height from the surface of the second lower clad layer) was 70 μm, a height from the substrate surface to the top surface of the upper clad layer was 90 μm, and a thickness of the optical signal transmission core pattern 23b was 50 μm.

### Fifth-A Step and Sixth Step

### Formation of Optical Path Changing Mirror

The V-shaped groove 30 at an angle of 45° was formed in the optical fiber connector main body obtained as above from the upper clad layer side using a dicing saw (DAC552 available from DISCO Corporation). Subsequently, a metal mask opened in mirror forming portions was set to the optical fiber connector main body with a mirror and Au was vapor-deposited to a thickness of 0.5 μm as the vapor-deposited metal layer using a deposition device (RE-0025 available from First Giken Co., Ltd.). The optical path changing mirrors 31 were thus formed.

### Fourth Step

### Formation of Lid Member

The protection film was peeled off from the 10-μm-thick clad layer forming resin film obtained as above as the adhesion layer 42 and the resulting film was laminated on a polyimide film (UPILEX® RN with a thickness of 25 μm available from Ube-Nitto Kasei Co., Ltd.) under the same conditions as above using a vacuum laminator. The lid member 40 with the adhesive layer 42 was thus formed. Subsequently, the carrier film was peeled off from the clad layer forming resin film laminated on the lid member 40 and the lid member 40 was heated and press-fit to the optical fiber connector as above from the upper clad layer forming surface side using a vacuum laminator under the same conditions as above. The resulting laminated body was cured by heating at 180° C. for one hour. The optical fiber connector 1A with the lid member 40 was thus formed.

A height of the fiber guide grooves 32 from the surface of the substrate 10 (second lower clad layer 13) to the bottom surface of the lid member 40 (bottom surface of the adhesive layer 42 of the lid member) was 90 μm.

In the optical fiber connector 1A thus obtained, a thickness of the lower clad layer was 20 μm, a thickness of the optical signal transmission core pattern 23b was 50 μm, a thickness of the upper clad layer from the top surface of the optical signal transmission core pattern 23b to the bottom surface of the lid member 40 was 20 μm, and a width of the fiber grooves 32 was 80 μm.

### Step of Forming Adhesive Introduction Slit

In order to smoothen the optical fiber connection end face of the obtained optical waveguide 3, a 40-μm-wide adhesive introduction slit 25A also serving as a slit groove was formed using a dicing saw (DAC552 available from DISCO Corporation). Also, outline machining was applied by cutting the substrate 10 parallel to the fiber guide core pattern 23a (point 3 mm away from the optical waveguide end face) for the fiber guide grooves 32 to appear on the substrate end face.

The core layer forming resin varnish described above was dropped as an adhesive from the adhesive introduction slit 25A in the optical fiber connector 1A obtained as described above and the 125-μm-pitch four-channel optical fiber 50 (core diameter of 50 μm and clad diameter of 80 μm) was inserted into a space defined by the fiber guide grooves 32 and the lid member 40. The optical fiber connector 1A was cured by heating at 180° C. for one hour. Consequently, the optical fiber 50 joined the optical transmission surface of the optical signal transmission core pattern 23b of the optical waveguide 3. When an optical signal was transmitted from the optical fiber 50, an optical loss was 1.53 dB. The result is set forth in Table 1 below.

### Examples 2 to 19

Operations same as those in Example 1 above were performed except that the thickness of the lower clad layer resin film, the thickness of the core layer forming resin film, the thickness of the upper clad layer resin film, the shape of the core pattern forming negative photomask were adjusted from those in Example 1 above as needed and dimensions of the respective portions of the optical fiber connector 1A were set as set forth in Table 1 below. Also, values of an optical loss were measured in the same manner as in Example 1 above. The results are set forth in Table 1 and Table 2 below.

TABLE 1

| | | | | | | | width W | | | | |
|---|---|---|---|---|---|---|---|---|---|---|---|
| | optical | | | | | | of fiber | | | | |
| | fiber | | first lower clad | | upper | | guide | | optical | | adhesive |
| | diameter | | layer | | clad layer | | groove | | propagation | optical | viscosity |
| | clad | core | thickness | α1 | thickness | α2 | width | α3 | core pattern | loss | at 25° C. |
| Example | μm | μm | μm | μm | μm | μm | μm | μm | μm | dB | mPa · S |
| 1 | 80 | 50 | 20 | 5 | 20 | 5 | 85 | 5 | 50 | 1.53 | 290 |
| 2 | 80 | 50 | 22 | 7 | 22 | 7 | 85 | 5 | 50 | 1.49 | 290 |
| 3 | 80 | 50 | 17 | 2 | 17 | 2 | 88 | 8 | 50 | 1.46 | 290 |
| 4 | 125 | 50 | 39 | 1.5 | 39 | 1.5 | 132 | 7 | 50 | 1.32 | 290 |
| 5 | 125 | 50 | 42 | 4.5 | 42 | 4.5 | 132 | 7 | 50 | 1.46 | 290 |
| 6 | 125 | 50 | 45 | 7.5 | 45 | 7.5 | 140 | 15 | 50 | 1.74 | 290 |
| 7 | 125 | 50 | 50 | 12.5 | 50 | 12.5 | 153 | 28 | 50 | 1.99 | 290 |
| 8 | 125 | 62.5 | 38 | 6.8 | 38 | 6.8 | 132 | 7 | 63 | 1.73 | 290 |
| 9 | 125 | 62.5 | 40 | 8.8 | 40 | 8.8 | 132 | 7 | 63 | 1.66 | 290 |
| 10 | 125 | 62.5 | 42 | 10.8 | 42 | 10.8 | 140 | 15 | 63 | 1.55 | 290 |
| 11 | 125 | 80 | 30 | 7.5 | 30 | 7.5 | 132 | 7 | 80 | 1.64 | 290 |
| 12 | 125 | 80 | 35 | 12.5 | 35 | 12.5 | 140 | 15 | 80 | 1.63 | 290 |
| 13 | 125 | 80 | 37 | 14.5 | 37 | 14.5 | 153 | 28 | 80 | 1.92 | 290 |
| 14 | 125 | 50 | 44 | 6.5 | 44 | 6.5 | 132 | 7 | 38 | 1.32 | 290 |
| 15 | 125 | 50 | 47 | 9.5 | 47 | 9.5 | 132 | 7 | 38 | 1.45 | 290 |
| 16 | 125 | 50 | 50 | 12.5 | 50 | 12.5 | 140 | 15 | 38 | 1.91 | 290 |

TABLE 2

| | | | | | | | width W | | | | |
|---|---|---|---|---|---|---|---|---|---|---|---|
| | optical | | | | | | of fiber | | | | |
| | fiber | | first lower | | upper | | guide | | optical | | adhesive |
| | diameter | | clad layer | | clad layer | | groove | | propagation | optical | viscosity |
| | clad | core | thickness | α1 | thickness | α2 | width | α3 | core pattern | loss | at 25° C. |
| Example | μm | μm | μm | μm | μm | μm | μm | μm | μm | dB | mPa · S |
| 17 | 80 | 50 | 32 | 17 | 32 | 17 | 85 | 5 | 50 | 2.32 | 290 |
| 18 | 80 | 50 | 32 | 17 | 15 | 0 | 88 | 8 | 50 | 2.98 | 290 |
| 19 | 125 | 50 | 55 | 17.5 | 55 | 17.5 | 135 | 15 | 50 | 2.5 | 290 |

### Example 20

### Manufacturing of Optical Fiber Connector 1

### First Step

An operation was performed in the same manner as in the first step of Example 1 above except that a 15-μm-thick lower clad layer forming resin film was used instead of the 20-μm-thick lower clad layer forming resin film.

### Second Step

An operation was performed in the same manner as in the second step of Example 1 above.

### Third Step

An operation was performed in the same manner as in the third step of Example 1 above except that an 85-μm-thick upper clad layer forming resin film was used instead of the 70-μm-thick upper clad layer forming resin film and the pressure during the process of press-fitting under pressure was changed to 0.4 MPa from 0.35 MPa.

### Fifth Step and Sixth Step

### Formation of Slit Groove

In order to smoothen the optical fiber connection end face of the obtained optical fiber connector main body, the 40-μm-wide slit groove 25 was formed using a dicing saw (DAC552 available from DISCO Corporation). Also, outline machining was applied by cutting the substrate parallel to the fiber guide side core pattern 23a (point 3 mm away from the optical waveguide end face) for the fiber guide grooves 32 to appear on the substrate end face.

### Formation of Optical Path Changing Mirror

The V-shaped groove 30 at an angle of 45° was formed in the obtained optical fiber connector main body from the upper clad layer side using a dicing saw (DAC552 available from DISCO Corporation). Subsequently, a metal mask opened in mirror forming portions was set to the optical fiber connector with a mirror and Au was vapor-deposited to a thickness of 0.5 μm as the vapor-deposited metal layer 12a using a deposition device (RE-0025 available from First Giken Co., Ltd.). The optical path changing mirrors 31 were thus formed.

### Fourth Step

An operation was performed in the same manner as in the fourth step of Example 1 above except that the height from the surface of the substrate 10 to the bottom surface of the lid member 40 (bottom surface of the adhesive layer of the lid member 40) was changed to 82 μm from 90 μm.

The core layer forming resin varnish described above was dropped from the fiber guide grooves 32 in the optical fiber connector 1 obtained as described above and the 125-μm-pitch four-channel optical fiber 50 (core diameter of 50 μm and clad diameter of 80 μm) was inserted into a space defined by the fiber guide grooves 32 and the lid member 40. The optical fiber connector 1 was cured by heating at 180° C. for one hour. Consequently, the optical fiber 50 joined the optical transmission surface of the optical signal transmission core pattern 23b of the optical waveguide 3 and it was possible to transmit an optical signal from the optical fiber 50 without misalignment of the optical fiber 50.

### Example 21

### Manufacturing of Optical Fiber Connector 1A

### First Step

An operation was performed in the same manner as in the first step of Example 1 above except that a 15-μm-thick lower clad layer forming resin film was used instead of the 20-μm-thick lower clad layer forming resin film.

### Second Step

An operation was performed in the same manner as in the second step of Example 1 above.

### Third Step

An operation was performed in the same manner as in the third step of Example 1 above except that an 85-μm-thick upper clad layer forming resin film was used instead of the 70-μm-thick upper clad layer forming resin film and a pressure during the process of press-fitting under pressure was changed to 0.4 MPa from 0.35 MPa.

### Fifth-A Step and Sixth Step

Operations were performed in the same manner as in the fifth-A step and the sixth step of Example 1 above.

### Fourth Step

An operation was performed in the same manner as in the fourth step of Example 1 above except that the height from the surface of the substrate 10 to the bottom surface of the lid member 40 (the bottom surface of the adhesive layer of the lid member 40) was changed to 82 μm from 90 μm.

### Step of Forming Adhesive Introduction Slit

The optical fiber connector 1A was obtained by performing an operation in the same manner as in the step of forming the adhesive introduction slit in Example 1 above.

The core layer forming resin varnish described above was dropped from the adhesive introduction slit 25A in the optical fiber connector 1A obtained as described above and the 125-μm-pitch four-channel optical fiber 50 (core diameter of 50 μm and clad diameter of 80 μm) was inserted into a space defined by the fiber guide grooves 32 and the lid member 40. The optical fiber connector 1A was cured by heating at 180° C. for one hour. Consequently, the optical fiber 50 joined the optical transmission surface of the optical signal transmission core pattern 23b of the optical waveguide 3 and it was possible to transmit an optical signal from the optical fiber 50 without misalignment of the optical fiber 50.

### Example 22

### Manufacturing of Optical Fiber Connector 1B

Operations were performed in the same manner as in Example 21 above except that the step of forming the adhesive introduction slit was performed as follows.

### Step of Forming Adhesive Introduction Slit

In order to smoothen the optical fiber connection end face of the obtained optical waveguide 3, the 40-μm-wide adhesion introduction slit 25B also serving as a slit groove was formed using a dicing saw (DAC552 available from DISCO Corporation). Also, outline machining was applied by cutting the lid member 40 parallel to the fiber guide core pattern 23a (point 3 mm away from the optical waveguide end face) for the fiber guide grooves 32 to appear on the lid member end face.

The core layer forming resin varnish described above was dropped from the adhesive introduction slit 25B in the optical fiber connector 1B obtained as described above and the 125-μm-pitch four-channel optical fiber 50 (core diameter of 50 μm and clad diameter of 80 μm) was inserted into a space defined by the fiber guide grooves 32 and the lid member 40. The optical fiber connector 1B was cured by heating at 180° C. for one hour. Consequently, the optical fiber 50 joined the optical transmission surface of the optical signal transmission core pattern 23b of the optical waveguide 3 and it was possible to transmit an optical signal from the optical fiber 50 without misalignment of the optical fiber 50.

### Example 23

### Manufacturing of Optical Fiber Connector 1C

Operations were performed in the same manner as in Example 20 above except that the step of forming the adhesive introduction slit was performed as follows after the fourth step.

### Step of Forming Adhesive Introduction Slit

The 40-μm-wide adhesive introduction slit 25C was formed using a dicing saw (DAC552 available from DISCO Corporation Ltd.). The adhesive introduction slit 25C was formed by applying outline machining by cutting the lid member 40 parallel to the fiber guide core pattern 23a (point 3 mm away from the optical waveguide end face) for the fiber guide grooves 32 to appear on the lid member end face.

The core layer forming resin varnish described above was dropped from the adhesive introduction slit 25C in the optical fiber connector 1C obtained as described above and the 125-μm-pitch four-channel optical fiber 50 (core diameter of 50 μm and clad diameter of 80 μm) was inserted into a space defined by the fiber guide grooves 32 and the lid member 40. The optical fiber connector 1C was cured by heating at 180° C. for one hour. Consequently, the optical fiber 50 joined the optical transmission surface of the optical signal transmission core pattern 23b of the optical waveguide 3 and it was possible to transmit an optical signal from the optical fiber 50 without misalignment of the optical fiber 50.

### Example 24

### Manufacturing of Optical Fiber Connector 1D

Operations were performed in the same manner as in Example 20 above except that the step of forming the adhesive introduction slit was performed as follows after the fourth step.

### Step of Forming Adhesive Introduction Slit

In order to smoothen the optical fiber connection end face of the obtained optical waveguide 3, the 40-μm-wide adhesive introduction slit 25D also serving as a slit groove was formed using a dicing saw (DAC552 available from DISCO Corporation). The adhesive introduction slit 25D was formed by applying outline machining by cutting the substrate 10 parallel to the fiber guide core pattern 23a (point 3 mm away from the optical waveguide end face) for the fiber guide grooves 32 to appear on the lid member end face.

The core layer forming resin varnish described above was dropped from the adhesive introduction slit 25D in the optical fiber connector 1D obtained as described above and the 125-μm-pitch four-channel optical fiber 50 (core diameter of 50 μm and clad diameter of 80 μm) was inserted into a space defined by the fiber guide grooves 32 and the lid member 40. The optical fiber connector 1D was cured by heating at 180° C. for one hour. Consequently, the optical fiber 50 joined the optical transmission surface of the optical signal transmission core pattern 23b of the optical waveguide 3 and it was possible to transmit an optical signal from the optical fiber 50 without misalignment of the optical fiber 50.

### INDUSTRIAL APPLICABILITY

As has been described in detail above, the optical fiber connector of the present invention facilitates alignment of an optical fiber and an optical waveguide core independently of a substrate with hardly any misalignment of the optical fiber. Moreover, an optical fiber and the optical waveguide can be easily coupled by merely inserting the optical fiber into a space defined by the grooves and the lid member.

The optical fiber connector of the present invention is therefore useful as an photo-electric conversion substrate for optical fiber and the like.

### REFERENCE SIGNS LIST

1, 1A, 1B, 1C, and 1D: optical fiber connector
2: optical fiber guide member
3: optical waveguide
10: substrate
22a: fiber guide side first lower clad layer
22b: optical waveguide side first lower clad layer
23a: fiber guide core pattern
23b: optical signal transmission core pattern
24a: fiber guide side upper clad layer
24b: optical waveguide side upper clad layer
25: slit groove
25A, 25B, 25C, and 25D: adhesive introduction slit
30: V-shaped groove
31: optical path changing mirror
32: fiber guide groove
40: lid member
50: optical fiber

1. An optical fiber connector having an optical fiber guide member and an optical waveguide,
wherein:
the optical fiber guide member includes a fiber guide side substrate portion forming part of a substrate, a fiber guide pattern on the fiber guide side substrate portion, and a lid member covering the fiber guide pattern;
the optical waveguide includes an optical waveguide side substrate portion adjacent to the fiber guide side substrate portion of the substrate, an optical waveguide side first lower clad layer on the optical waveguide side substrate portion, an optical signal transmission core pattern on the optical waveguide side first lower clad layer, and an optical waveguide side upper clad layer on the optical signal transmission core pattern;
the fiber guide pattern is formed of a plurality of guide members aligned parallel to one another at intervals;
a space defined by every two adjacent guide members, the fiber guide side substrate portion, and a fiber guide side lid member portion forms a fiber guide groove; and
the fiber guide groove is present on an extension of the optical signal transmission core pattern in an optical path direction.

2. The optical fiber connector according to claim 1, wherein:
the fiber guide pattern is formed of a fiber guide side first lower clad layer on the fiber guide side substrate portion, a fiber guide core pattern on the fiber guide side substrate portion, and a fiber guide side upper clad layer on the fiber guide core pattern.

3. The optical fiber connector according to claim 1, wherein:
the optical fiber guide member has an adhesive introduction slit that allows an outside of the optical fiber guide member and the fiber guide groove to communicate.

4. The optical fiber connector according to claim 1, wherein:
a surface layer of the substrate on a side on which are present the optical waveguide side first lower clad layer and the fiber guide side first lower clad layer is an adhesive layer.

5. The optical fiber connector according to claim 1, wherein:
the adhesive layer is a second lower clad layer.

6. The optical fiber connector according to claim 1, wherein:
the optical waveguide has an optical path changing mirror on an optical path of the optical signal transmission core pattern;
the lid member has a fiber guide side lid member portion covering a side of the fiber guide pattern and an optical waveguide side lid member portion covering the optical path changing mirror; and
the optical waveguide side lid member portion forms a reinforcement portion of the optical path changing mirror.

7. The optical fiber connector according to claim 1, wherein:
the substrate is an electric wiring board.

8. The optical fiber connector according to claim 1, wherein:
a width of the fiber guide groove is equal to or greater than a diameter of an optical fiber fixed to the optical fiber guide member and a height of the fiber guide groove is equal to or greater than the diameter of the optical fiber.

9. The optical fiber connector according to claim 1, wherein:
a value α1, which is found by subtracting a radius of an optical fiber fixed to the optical fiber guide member from a distance between the substrate and a center of the optical signal transmission core pattern in a height direction, is in a range of 0.5 to 15 μm; and
a value α2, which is found by subtracting a diameter of the optical fiber from a height of the fiber guide groove, is in a range of 1.0 to 30 μm.

10. The optical fiber connector according to claim 9, wherein:
a value α3, which is found by subtracting the radius of the optical fiber fixed to the optical fiber guide member from a distance between the center of the optical signal transmission core pattern in the height direction and the lid member, is in a range of 0.5 to 15 μm.

11. The optical fiber connector according to claim 9, wherein:
an absolute value α4 of a difference between a value α3, which is found by subtracting the radius of the optical fiber fixed to the optical fiber guide member from a distance between the center of the optical signal transmission core pattern in the height direction and the lid member, and the value α1 is in a range of 0 to 7.5 μm.

12. The optical fiber connector according to claim 1, wherein:
a value α5, which is found by subtracting a diameter of the optical fiber from a width of the fiber guide groove is in a range of 1.0 μm to 30 μm.

13. A method for manufacturing the optical fiber connector according to claim 1, including:
a first step of forming an optical waveguide side first lower clad layer by laminating a first lower clad layer on a substrate and etching away the first lower clad layer present in a region in which a fiber guide groove is to be formed;
a second step of collectively forming a fiber guide core pattern and an optical signal transmission core pattern by means of etching after a core forming resin layer is laminated on the substrate on which the optical waveguide side first lower clad layer is formed;
a third step of forming a fiber guide side upper clad layer, an optical waveguide side upper clad layer, and a fiber guide groove by laminating an upper clad layer forming resin layer on the substrate on which the fiber guide core pattern and the optical signal transmission core pattern are formed and etching away the upper clad layer forming resin layer preset in a region in which the fiber guide groove is to be formed; and
a fourth step of forming a lid member covering the fiber guide groove.

14. The method for manufacturing the optical fiber connector according to claim 13, further including:
a fifth step of forming a slit groove on a surface of the substrate along a boundary between the fiber guide groove and the optical path waveguide side lower clad layer, which step is performed after the third step.

15. The method for manufacturing the optical fiber connector according to claim 13, wherein:
an adhesive introduction slit penetrating through the substrate in a thickness direction and thereby communicating with the fiber guide groove is formed after the third step or the fourth step.

16. The method for manufacturing the optical fiber connector according to claim 13, wherein:
an adhesive introduction slit penetrating through the lid member in a thickness direction and thereby communicating with the fiber guide groove is formed after the fourth step.

17. A method for connecting an optical fiber connector and an optical fiber, including:
a step of filling an adhesive in the fiber guide groove of the optical fiber connector according to claim 1 and inserting and installing an optical fiber in the fiber guide groove.

18. An assembled body of an optical fiber connector and an optical fiber, having:
the optical fiber connector according to claim 1; and
an optical fiber and an adhesive installed in the fiber guide groove of the optical fiber connector.
